(19) United States
(12) Patent Application Publication
(10) Pub. No.: US 2008/0092089 A1
(43) Pub. Date: Apr. 17, 2008

(54) CAD data processing apparatus, CAD data processing method, and computer product

(75) Inventor: Hideo Kobayashi, Kawasaki (JP)

Correspondence Address: STAAS & HALSEY LLP, SUITE 700, 1201 NEW YORK AVENUE, N.W., WASHINGTON, DC, 20005, US

(73) Assignee: FUJITSU LIMITED, Kawasaki (JP)

(21) Appl. No.: 11/700,144

(22) Filed: Jan. 31, 2007

(30) Foreign Application Priority Data
Sep. 28, 2006 (JP) 2006-265881

(51) Int. Cl. G06F 17/50

(52) U.S. Cl. 716/1; 715/211

(57) ABSTRACT

A CAD data processing apparatus acquires first net information and second net information through an input unit, and stores the information in a storage unit. A correlation processor creates an association table that associates components, terminals, and nets contained in the first net information with components, terminals, and nets contained in the second net information based on characteristics of the terminals of the components contained in the first net information and the second net information.

### BACKGROUND OF THE INVENTION

1. Field of the Invention

The present invention relates to a technology for correlating computer aided design (CAD) data created by different CADs.

2. Description of the Related Art

Various computer-aided designs (CADs) have been widely used depending on purposes to enhance the work efficiency of designing, drafting, and the like. When CAD data are created using different CADs and are to be processed, the CAD data need to be correlated with one another.

For example, when CAD data created using a circuit design CAD and a package design CAD are used in an evaluation test of a printed circuit board, the CAD data created by the circuit design CAD needs to be correlated with the CAD data created by the package design CAD.

Japanese Patent Application Laid-Open No. H11-25142 discloses a technique for facilitating CAD design by creating, beforehand, list data that correlates diagram data indicating shapes of graphics and attribute data of the graphics.

However, with the conventional technology, to correlate CAD data, it is essential that symbol names (names of components and terminals) and nets (circuit connections) contained in the respective CAD data match. If a match is not achieved between part or all of components and terminal names, net names, and net connections, the CAD data cannot be correlated.

For example, when rules for naming symbols differ between different CADs (e.g., when CAD 1 has symbol names, of A1, A2, A3, . . . , and CAD 2 has symbol names of 1, 2, 3, . . . ), it is impossible to correlate these CAD data.

It is often the case that rules for naming symbols, etc. differ between different CADs, which makes it impossible to correlate the CAD data. Therefore, there is a need of a technology for correlating CAD data appropriately even when nets and symbol names of circuits contained in each CAD data do not match.

### SUMMARY OF THE INVENTION

It is an object of the present invention to at least partially solve the problems in the conventional technology.

According to an aspect of the present invention, a CAD data processing apparatus that correlates CAD data created by different CADs, the CAD data including data on components having a terminal that constitute a circuit and a net that connects the components, includes a storage unit that stores therein first CAD data created by a first CAD and second CAD data created by a second CAD, and a correlating unit that correlates the first CAD data with the second CAD data based on characteristics of terminals of components indicated by the first CAD data and the second CAD data.

According to another aspect of the present invention, a CAD data processing method for correlating CAD data created by different CADs, the CAD data including data on components having a terminal that constitute a circuit and a net that connects the components, includes storing first CAD data created by a first CAD and second CAD data created by a second CAD, and correlating the first CAD data with the second CAD data based on characteristics of terminals of components indicated by the first CAD data and the second CAD data.

According to still another aspect of the present invention, a computer-readable recording medium stores therein a computer program that causes a computer to implement the above method.

The above and other objects, features, advantages and technical and industrial significance of this invention will be better understood by reading the following detailed description of presently preferred embodiments of the invention, when considered in connection with the accompanying drawings.

### BRIEF DESCRIPTION OF THE DRAWINGS

FIG. 1 is a functional block diagram of a CAD data processing apparatus according to an embodiment of the present invention;

FIG. 2 is one example of a data structure of first net information shown in FIG. 1;

FIG. 3 is one example of a data structure of second net information shown in FIG. 1;

FIG. 4 is one example of contents of a circuit-design pin-count table shown in FIG. 1;

FIG. 5 is one example of contents of a package-design pin-count table shown in FIG. 1;

FIG. 6 is one example of contents of a circuit-design terminal-information table shown in FIG. 1;

FIG. 7 is one example of contents of a package-design terminal-information table shown in FIG. 1;

FIG. 8 is one example of contents of a rule information table shown in FIG. 1;

FIG. 9 is one example of contents of an association table shown in FIG. 1;

FIG. 10 is a functional block diagram of a correlation processor shown in FIG. 1;

FIG. 11 is a schematic for explaining the operation of a first correlation processor shown in FIG. 10;

FIGS. 12 and 13 are schematics for explaining the operation of a second correlation processor shown in FIG. 10;

FIG. 14 is a schematic for explaining the operation of a third correlation processor shown in FIG. 10;

FIG. 15 is one example of contents of a first circuit-design connection table shown in FIG. 1;

FIG. 16 is one example of contents of a first package-design connection table shown in FIG. 1;

FIG. 17 is a schematic for explaining the operation a fourth correlation processor shown in FIG. 10;

FIG. 18 is one example of contents of a second circuit-design connection table shown in FIG. 1;

FIG. 19 is one example of contents of a second package-design connection table shown in FIG. 1;

FIG. 20 is a schematic for explaining the operation of a fifth correlation processor shown in FIG. 10;

FIG. 21 is one example of contents of a third circuit-design connection table shown in FIG. 1;

FIG. 22 is one example of contents of a third package-design connection table shown in FIG. 1;

FIG. 23 is a flowchart of the operation of the first correlation processor;

FIG. 24 is a flowchart of the operation of the second correlation processor;

FIG. 25 is a flowchart of the operation of the third correlation processor;

FIG. 26 is a flowchart of the operation of the fourth correlation processor;

FIGS. 27 and 28 are flowcharts of the operation of the fifth correlation processor;

FIG. 29 is a flowchart of a process according to a basic method 1;

FIGS. 30 and 31 are flowcharts of a process according to a basic method 2;

FIG. 32 is a schematic for explaining a selection method 1;

FIG. 33 is a schematic for explaining a selection method 2;

FIG. 34 is a schematic for explaining a comprehensive determination method used by the correlation processor; and

FIG. 35 is a block diagram of a computer that constitutes the CAD data processing apparatus.

### DETAILED DESCRIPTION OF THE PREFERRED EMBODIMENTS

Exemplary embodiments of the present invention are explained in detail below with reference to the accompanying drawings.

First, an outline of a CAD data processing apparatus 100 according to an embodiment of the invention is explained. The CAD data processing apparatus 100 records first CAD data that indicates CAD data created by a first CAD (e.g., a circuit design CAD) and second CAD data (e.g., created by a package design CAD) in a recording device, and correlates based on characteristics of terminals of their components.

The CAD data processing apparatus 100 stores the first CAD data and the second CAD data, and correlates them based on characteristics of the terminals of their components. Consequently, the first CAD data can be appropriately correlated with the second CAD data even if symbol names, nets, etc. contained in the respective CAD data do not completely match. In the explanation below, the first CAD data is explained as first net information and the second CAD data is explained as second net information.

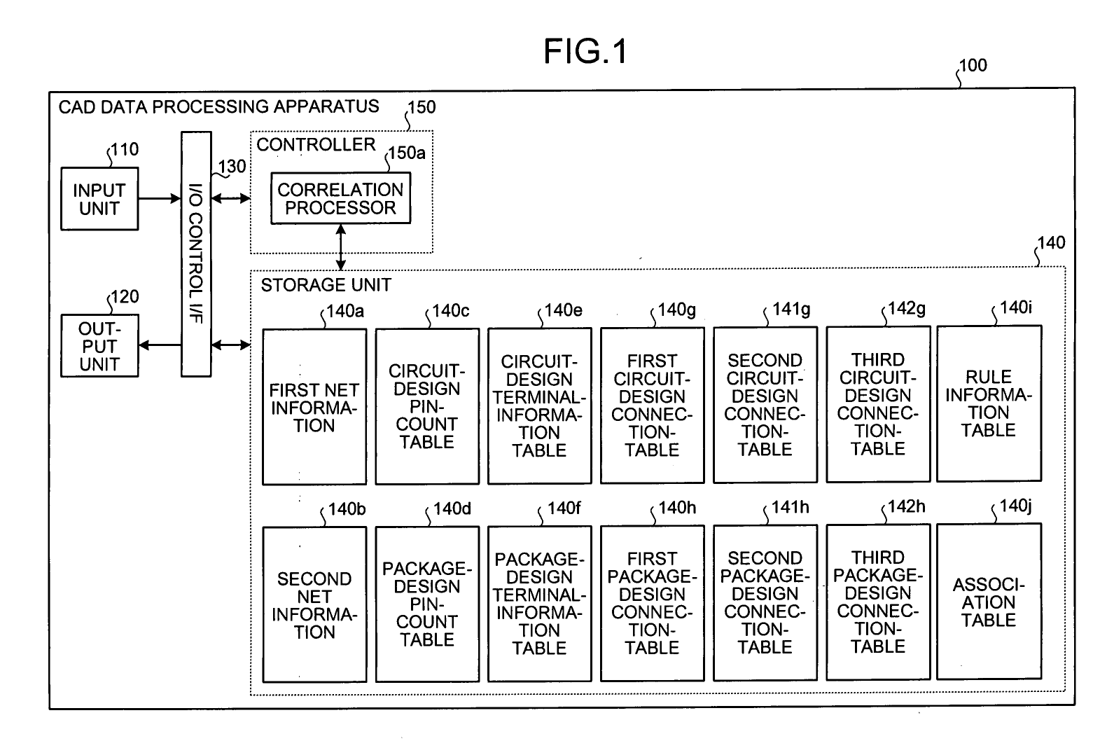

FIG. 1 is a functional block diagram of the CAD data processing apparatus 100. The CAD data processing apparatus 100 includes an input unit 110, an output unit 120, an input and output (I/O) control interface (I/F) 130, a storage unit 140, and a controller 150.

The input unit 110 inputs various information, and includes a keyboard, a mouse, and a microphone. A monitor (output unit 120) (described later) realizes functions of a pointing device and operates in conjunction with the mouse.

The output unit 120 outputs various information, and includes a monitor (a display or a touch panel), and a speaker. The I/O control interface I/F 130 controls input and output of data by the input unit 110 and the output unit 120.

The storage unit 140 stores therein data and programs required in various processes by the controller 150. Data particularly closely related to the present invention that are stored in the storage unit 140 include, as shown in FIG. 1, first net information 140a, second net information 140b, a circuit-design pin-count table 140c, a package-design pin-count table 140d, a circuit-design terminal-information table 140e, a package-design terminal-information table 140f, a first circuit-design connection table 140g, a second circuit-design connection table 141g, a third circuit-design connection table 142g, a first package-design connection table 140h, a second package-design connection table 141h, a third package-design connection table 142h, a rule information table 140i, and an association table 140j.

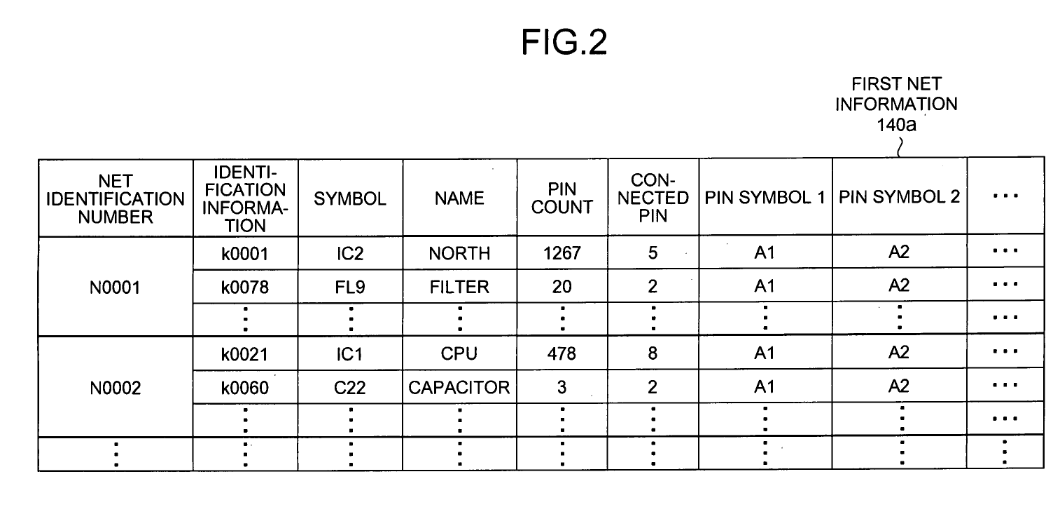

The first net information 140a is data corresponding to CAD data created by a circuit design CAD (hereinafter, “circuit design CAD data”). FIG. 2 is one example of a data structure of the first net information 140a. The first net information 140a contains items including net identification number that identifies a net connected to each component, identification information that identifies a component (component, terminal, and net related to the circuit design CAD data) connected to a net, symbol, name, pin count indicating the number of terminals of a component, connected pin indicating a number assigned to a terminal connected to a net, and pin symbol 1, pin symbol 2, . . . indicating a symbol of each terminal. The first net information 140a is input by a user from the input unit 110, and stored in the storage unit 140.

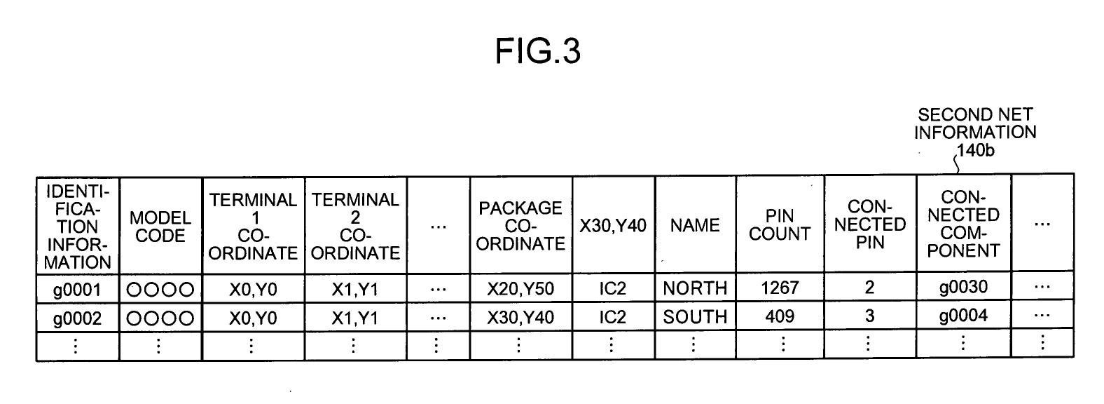

The second net information 140b is data corresponding to CAD data created by a package design CAD (hereinafter, “package design CAD data”). FIG. 3 is one example of a data structure of the second net information 140b. The second net information 140b contains items including identification information that identifies a component (component, terminal, and net related to the package design CAD data), model code, terminal 1 coordinates and terminal 2 coordinates each indicating coordinates of a terminal with respect to a component, package coordinates indicating coordinates of a component with respect to a printed circuit board, symbol, name, pin count, connected pin, and connected component indicating a connection relationship between components (the first line of the second net information 140b shown in FIG. 3 indicates that a component identified by an identification number “g0001” is connected to a component identified by an identification number “g0030”).

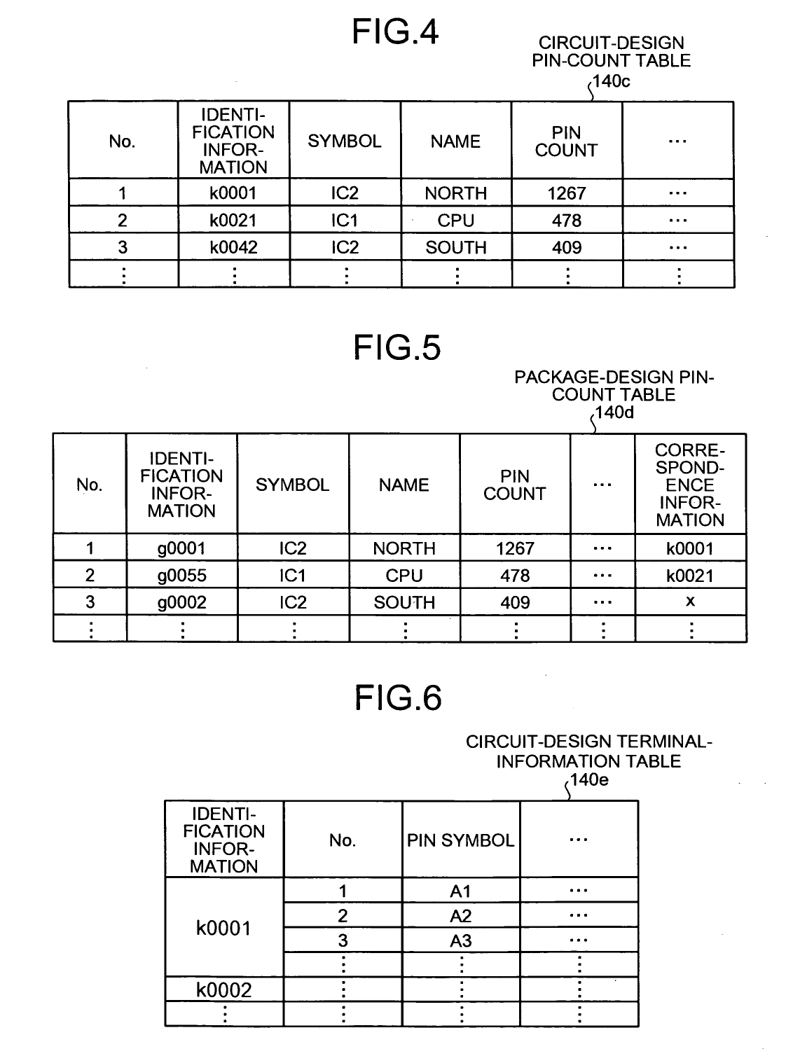

The circuit-design pin-count table 140c is data obtained by sorting the components contained in the first net information 140a in descending order of their pin counts. FIG. 4 is one example of a data structure of the circuit-design pin-count table 140c. The circuit-design pin-count table 140c contains items including number (No.), identification information, symbol, name, and pin count. The circuit-design pin-count table 140c is created by a correlation processor 150a (described later).

The package-design pin-count table 140d is data obtained by sorting the components contained in the second net information 140b in descending order of their pin counts. FIG. 5 is one example of a data structure of the pack-age-design pin-count table 140d. The package-design pin-count table 140d contains items including number (No.), identification information, symbol, name, pin count, and correspondence information. The correspondence information correlates a component contained in the first net information 140a with a component contained in the second net information 140b. The package-design pin-count table 140d is created by the correlation processor 150a.

The circuit-design terminal-information table 140e is data obtained by extracting a pin symbol contained in the first net information 140a for each component. FIG. 6 is one example of a data structure of the circuit-design terminal-information table 140e. The circuit-design terminal-information table 140e contains items including identification information, number (No.), and pin symbol. The circuit-design terminal-information table 140e is created by the correlation processor 150a.

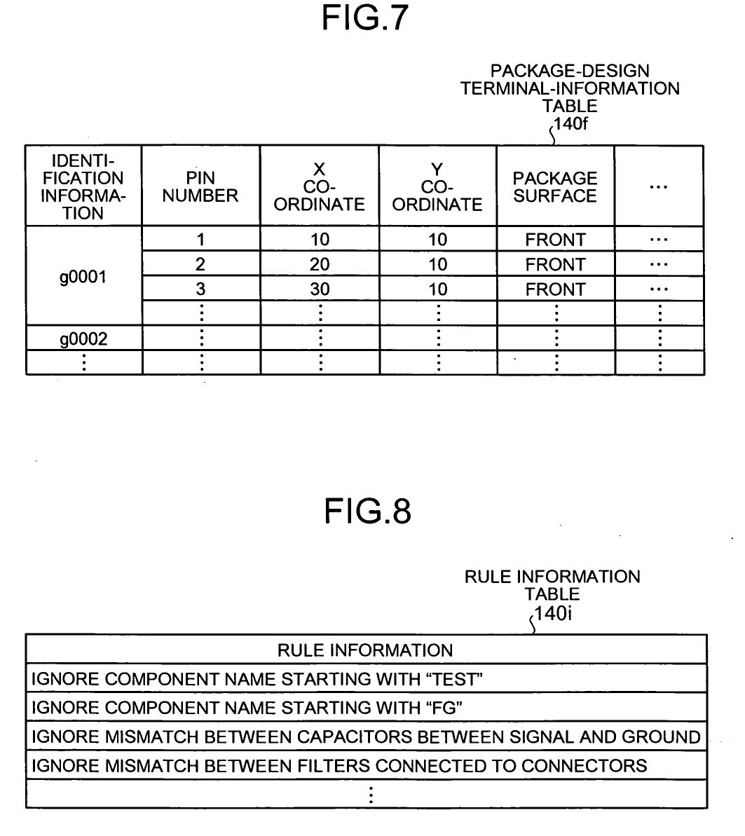

The package-design terminal-information table 140f is data obtained by extracting arrangement information of terminals (pins) of a component, based on the second net information 140b. FIG. 7 is one example of a data structure of the package-design terminal-information table 140f. The package-design terminal-information table 140f contains items including identification information, pin number, X coordinate, Y coordinate, and package surface. The package-design terminal-information table 140f is created by the correlation processor 150a.

The first circuit-design connection table 140g, the second circuit-design connection table 141g, and the third circuit-design connection table 142g include data indicating connection relationships between the components contained in the first net information 140a. The first circuit-design connection table 140g, the second circuit-design connection table 141g, and the third circuit-design connection table 142g are created by the correlation processor 150a.

The first package-design connection table 140h, the second package-design connection table 141h, and the third package-design connection table 142h include data indicating connection relationships between the components contained in the second net information 140b. The first package-design connection table 140h, the second package-design connection table 141h, and the third package-design connection table 142h are created by the correlation processor 150a.

The rule information table 140i is data obtained by recording rules that are applied when correlating components contained in the first net information 140a with components contained in the second net information 140b. FIG. 8 is one example of a data structure of the rule information table 140i. The rule information table 140i is input by the user from the input unit 110, and stored in the storage unit 140.

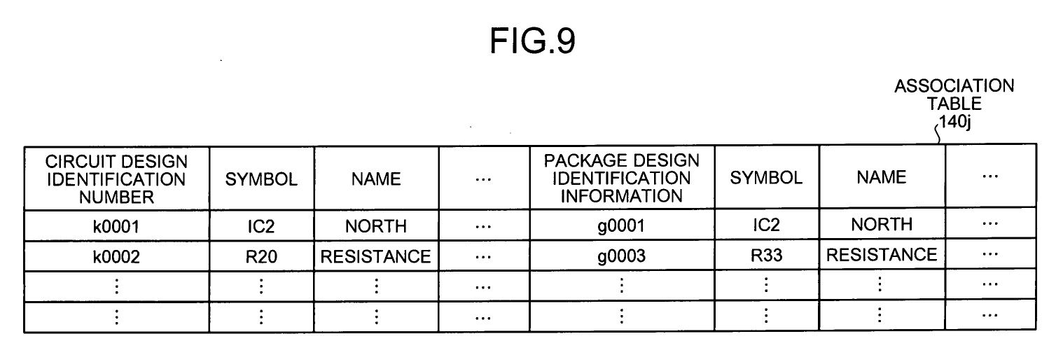

The association table 140j is data obtained by correlating components, terminals, and nets of the first net information 140a with components, terminals, and nets of the second net information 140b. FIG. 9 is one example of a data structure of the association table 140j. The association table 140j contains items including circuit design identification information that identifies a component, a terminal, and a net of the first net information 140a, symbol of a component, a terminal, and a net of the first net information 140a, name of a component, a terminal, and a net of the first net information 140a, package design identification information that identifies a component, a terminals, and a net of the second net information 140b, symbol of a component, a terminal, and a net of the second net information 140b, and name of a component, a terminal, and a net of the second net information 140b.

In the first line of FIG. 9, a component identified by circuit design identification information “k0001” is correlated with a component identified by package design identification information “g0001”. The association table 140j is created by the correlation processor 150a. The association table 140j created by the correlation processor 150a is output to the output unit 120.

The controller 150 includes an internal memory for storing programs and control data that specify various processes, and performs the various processes with the programs and control data. The controller 150 also includes the correlation processor 150a, which is of a particular relevance to the invention.

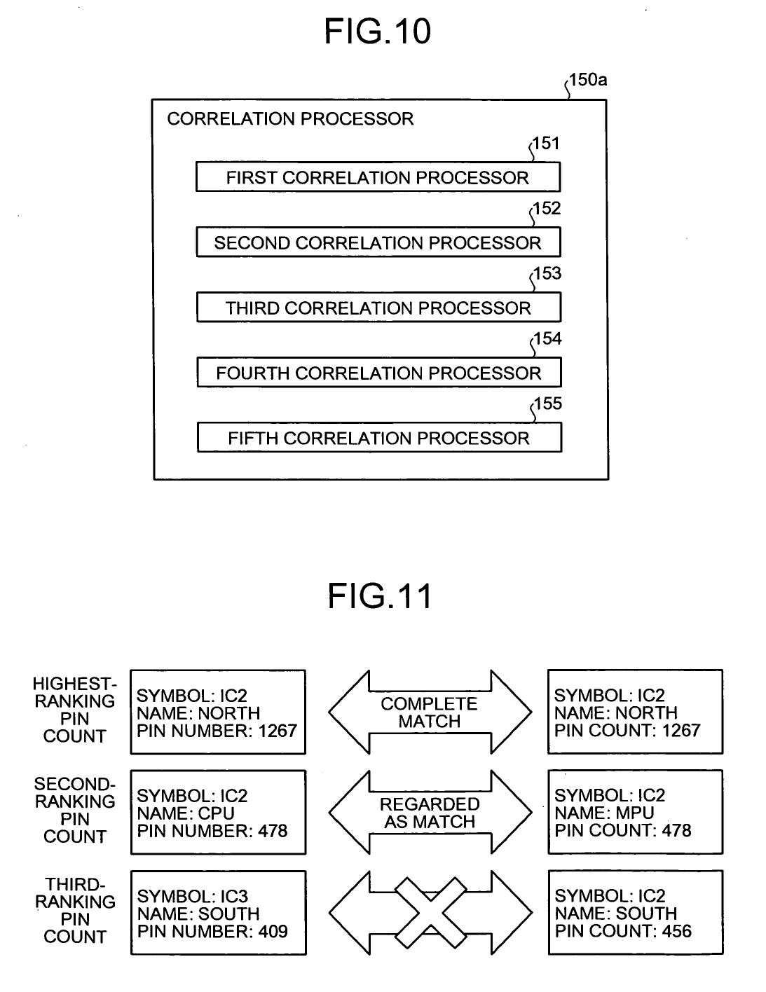

The correlation processor 150a correlates the components, the terminals, and the nets contained in the first net information 140a with the components, the terminals, and the nets contained in the second net information 140b. FIG. 10 is a functional block diagram of the configuration of the correlation processor 150a. The correlation processor 150a includes a first correlation processor 151, a second correlation processor 152, a third correlation processor 153, a fourth correlation processor 154, and a fifth correlation processor 155.

The first correlation processor 151 correlates the components of the first net information 140a with the components of the second net information 140b based on the number of terminals of the components. FIG. 11 is a schematic for explaining the operation of the first correlation processor 151. The first correlation processor 151 refers to the number of terminals (pin count) of the components for correlation. Upon determining that components to be correlated have the same number of pins, and that the pin count is ranked in the top three among all the components, the first correlation processor 151 correlates the components. In the first line of FIG. 11, the symbol, the names, and the pin counts match completely, and these two components are correlated.

In the second line of FIG. 11, although the symbols and the names are different, the pin counts are the same and both ranked second, and therefore, the two components are correlated. In the third line of FIG. 11, although the pin counts are both ranked third, the symbol, the names, and the pin counts are different, and these two components cannot be correlated.

As preparation for the process shown in FIG. 11, the first correlation processor 151 creates the circuit-design pin-count table 140c (see FIG. 4) by sorting the components in descending order of their pin counts based on the first net information 140a, and creates the package-design pin-count table 140d, (see FIG. 5) by sorting the components in descending order of their pin counts based on the second net information 140b. The first correlation processor 151 then compares the created circuit-design pin-count table 140c with the created package-design pin-count table 140d, and performs the process described with reference to FIG. 11.

The first correlation processor 151 registers information on the correlated components in the correspondence information of the package-design pin-count table 140d, and also in the association table 140j.

While in the embodiment, the first correlation processor 151 determines that components correspond when their pin counts are identical and ranked in the top three among all the components, it is not limited thereto. For example, components can be correlated when their pin counts are identical and exceed a predetermined value.

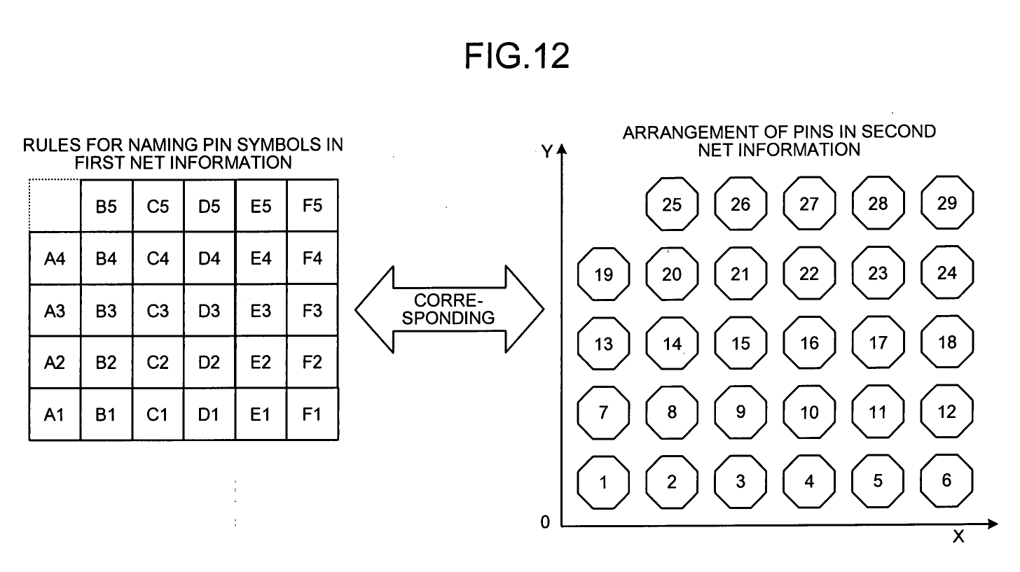

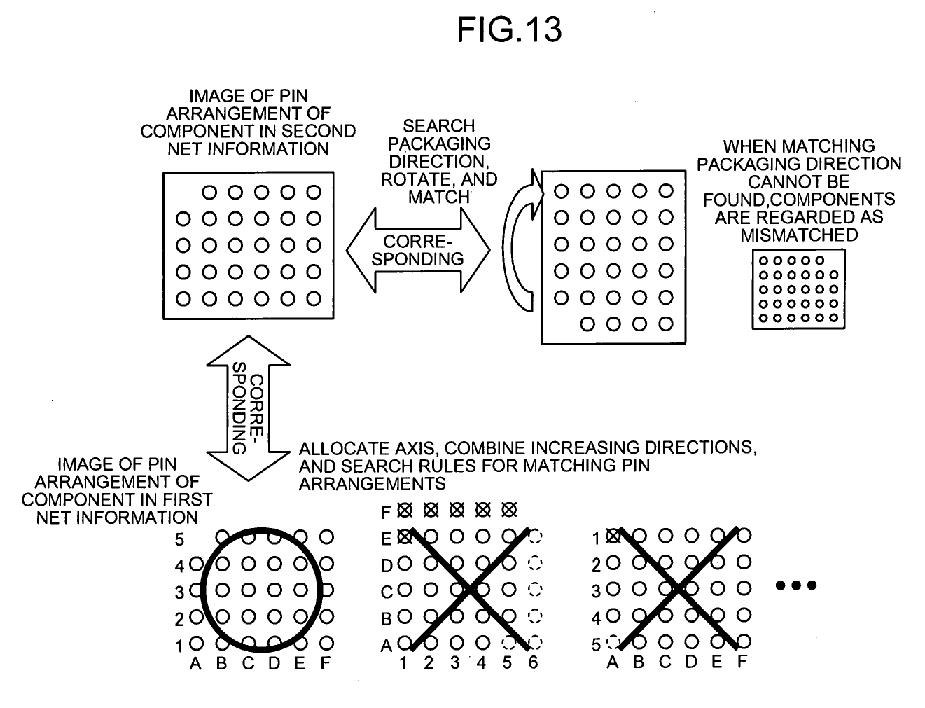

The second correlation processor 152 correlates the components of the first net information 140a with the components of the second net information 140b based on the arrangements of terminals of the components. FIGS. 12 and 13 are explanatory diagrams of processes of the second correlation processor 152. As shown in FIG. 12, the second correlation processor 152 correlates the components and the terminals of the first net information 140a with the components and the terminals of the second net information 140b, based on rules for naming of pin symbols, the arrangements of the pins, missing pins, excess pins, and the like. In the example shown in FIG. 12, the components are correlated because the rules for naming of pin symbols, pin arrangements, and missing pins are equal.

Specifically, the second correlation processor 152 creates the circuit-design terminal-information table 140e (see FIG. 6) and the package-design terminal-information table 140f (see FIG. 7) based respectively on the first net information 140a and the second net information 140b, and determines names of the terminals from the created circuit-design terminal-information table 140e and the created package-design terminal-information table 140f.

A method used by the second correlation processor 152 in determining a name of a terminal of a component in the first net information 140a based on the circuit-design terminal-information table 140e is explained. When all the pin symbols corresponding to the numbers of the circuit-design terminal-information table 140e are constituted by sequences of letters and numerals in this order, and the letters and the numerals of all the pin symbols include three or more types, the terminal name is determined to be “ball grid array” (BGA).

On the other hand, when all the pin symbols corresponding to the numbers of the circuit-design terminal-information table 140e are constituted by a sequence of letters and numerals or numerals and letters in this order, and the letters or the numerals of all the pin symbols include two or more types, the terminal name is determined to be “small outline package (SOP)”. The second correlation processor 152 determines whether the name of the terminal of the first net information 140a is BGA, and then determines whether it is SOP.

A method used by the second correlation processor 152 in determining a name of a terminal in second net information based on the package-design terminal-information table 140f is explained. Based on the X and Y coordinates related to each pin number in the package-design terminal-information table 140f, the second correlation processor 152 determines that the name of the terminal is BGA when each pin is arranged in a grid, there are three or more rows in the grid of the pin arrangement, and there are three or more lattices in the pin arrangement.

On the other hand, based on the X and Y coordinates related to each pin number in the package-design terminal-information table 140f, the second correlation processor 152 determines that the terminal name is SOP when two or more pins are arranged, and both rows of the pins are arranged at equal intervals. The second correlation processor 152 determines whether the name of the terminal related to the second net information 140b is BGA, and then determines whether it is SOP.

After determining the name of the terminal of the component in the first net information 140a and the name of the terminal of the component in the second net information 140b, the second correlation processor 152 selects components whose terminal names match, and creates a pin arrangement image for each component. As shown in FIG. 13, the second correlation processor 152 searches the direction of components whose pin arrangements match and, when they match, correlates the components, their terminals, and their nets. When the target for correlation is a circuit diagram, the second correlation processor 152 correlates only components whose arrangements can be estimated from their pin numbers such as BGAs. The second correlation processor 152 registers information relating to the correlated components, terminals, and nets in the association table 140j.

Even if physical terminal arrangements are not described in the first net information 140a and the second net information 140b, the second correlation processor 152 can determine the arrangements of the terminals from the terminal numbers contained in the first net information 140a and the second net information 140b, compare the determined terminal arrangements, correlate components of the first net information 140a with components of the second net information 140b, and register them in the association table 140j.

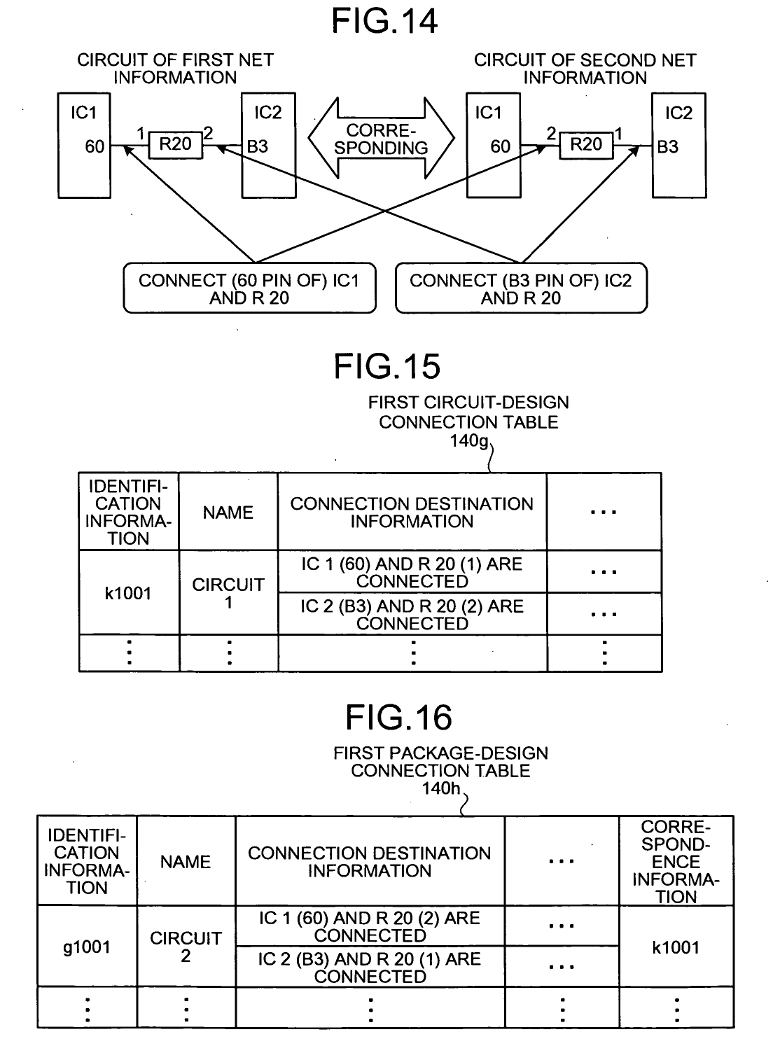

The third correlation processor 153 correlates circuits constituted by components and nets based on predetermined rules. FIG. 14 is a schematic for explaining the operation of the third correlation processor 153. The third correlation processor 153 compares a circuit of the first net information 140a (this circuit being constituted by components and nets) with a circuit of the second net information 140b, and, when their constituent components are correlated, and the same components are connected to the nets, correlates the circuits even if the pin numbers of the components connected to the nets are different.

Specifically, the third correlation processor 153 creates the first circuit-design connection table 140g based on the first net information 140a. FIG. 15 is one example of a data structure of the first circuit-design connection table 140g. The first circuit-design connection table 140g contains items including identification information that identifies circuits, names, and connection destination information. The first line of FIG. 15 indicates that the sixtieth pin of IC1 and the first pin of R20 are connected by a net.

The third correlation processor 153 creates the first package-design connection table 140h based on the second net information 140b. FIG. 16 is one example of a data structure of the first package-design connection table 140h. The first package-design connection table 140h contains items including identification information that identifies circuits, names, connection destination information, and correspondence information. The first line of FIG. 16 indicates that the sixtieth pin of IC1 and the second pin of R20 are connected by a net.

The third correlation processor 153 compares the first circuit-design connection table 140g, the first package-design connection table 140h, and the association table 140j. When the result of this comparison is that their components are correlated and their connection destination components are equal, the third correlation processor 153 correlates the two circuits even if their connected pin numbers are different. The third correlation processor 153 registers information on the correlated circuits in the first package-design connection table 140h and the association table 140j.

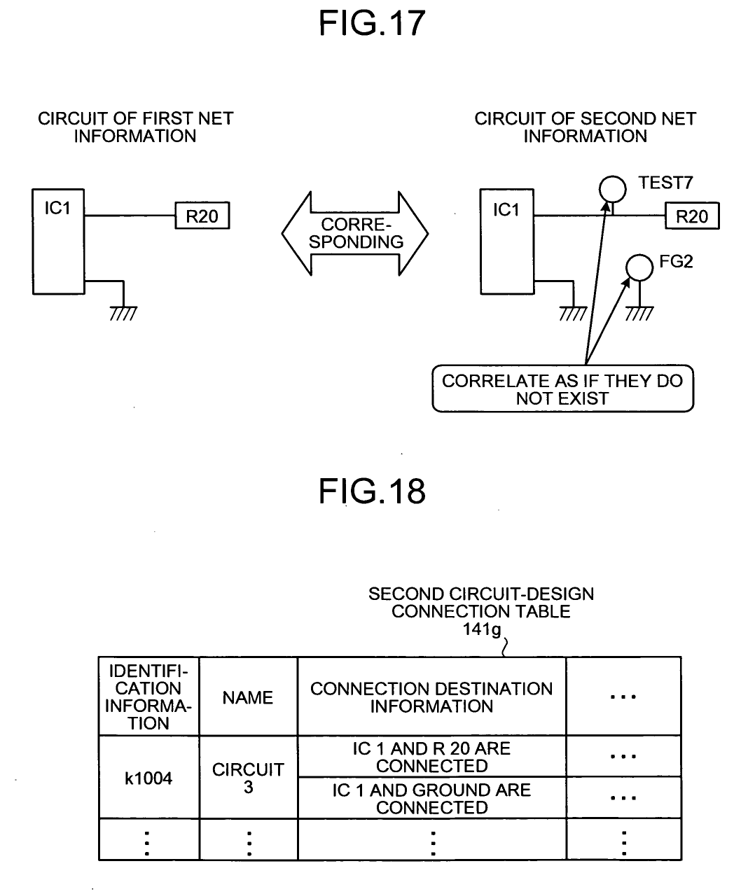

The fourth correlation processor 154 correlates circuits constituted by components and nets based on the rule information table 140i and predetermined rules. FIG. 17 is a schematic of the operation of the fourth correlation processor 154. The fourth correlation processor 154 determines a function (e.g., Large scale integration (LSI)/IC or resistor) of a component in a circuit based on its name, and, when the determined function is not required, correlates the circuits as if the function does not exist. In the example shown in FIG. 17, information indicating that a component function TEST7 need not match FG2 is recorded in the rule information table 140i (see FIG. 8), and therefore, these two functions are correlated.

Specifically, the fourth correlation processor 154 creates the second circuit-design connection table 141g based on the first net information 140a. FIG. 18 is one example of a data structure of the second circuit-design connection table 141g. The second circuit-design connection table 141g contains items including identification information that identifies the circuit, its name, and connection destination information. The first line of FIG. 18 indicates that IC1 and R20 are connected.

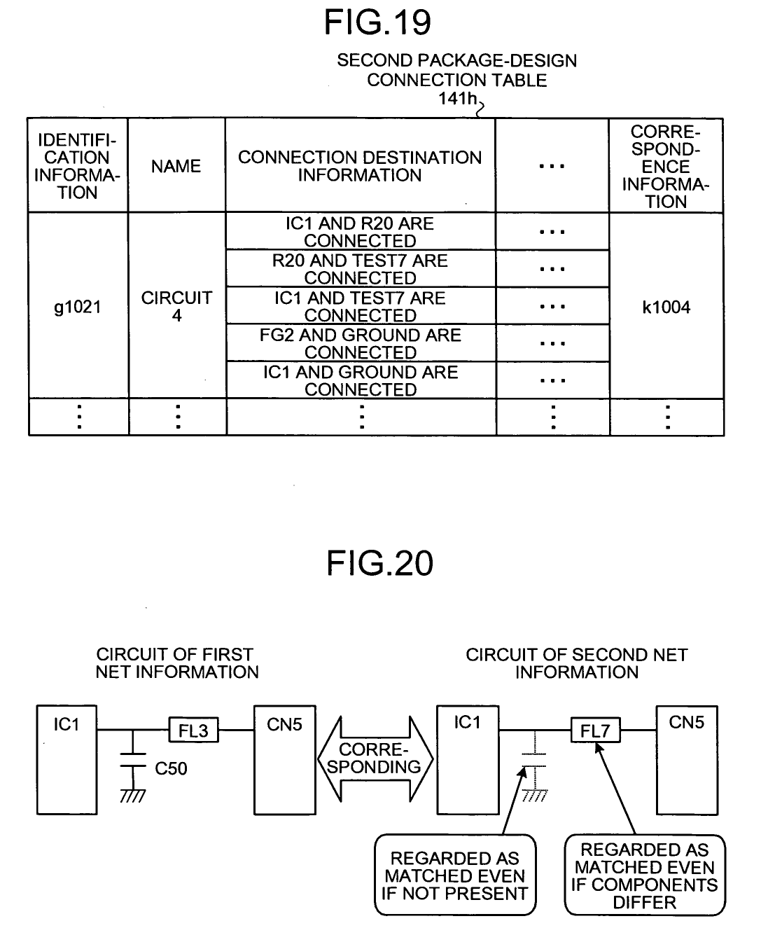

The fourth correlation processor 154 also creates the second package-design connection table 141h based on the second net information 140b. FIG. 19 is one example of a data structure of the second package-design connection table 141h. The second package-design connection table 141h contains items including identification information that identifies the circuit, its name, connection destination information, and correspondence information. The first line of FIG. 19 indicates that IC1 and R20 are connected.

The fourth correlation processor 154 determines the function of the components contained in each circuit, and correlates the circuits by comparing the second circuit-design connection table 141g, the second package-design connection table 141h, and the rule information table 140i. The fourth correlation processor 154 registers information on the correlated circuits in the second package-design connection table 141h and the association table 140j.

The fifth correlation processor 155 correlates the respective circuits based on predetermined rules even when their structures are different. FIG. 20 is a schematic for explaining the operation of the fifth correlation processor 155. As shown in FIG. 20, even if part of the components differ (FL3 and FL7 are different) and the circuits do not match (one includes C50), the circuits can be correlated because the rule information table 140i stipulates that a complete match or mismatch between them is not necessary.

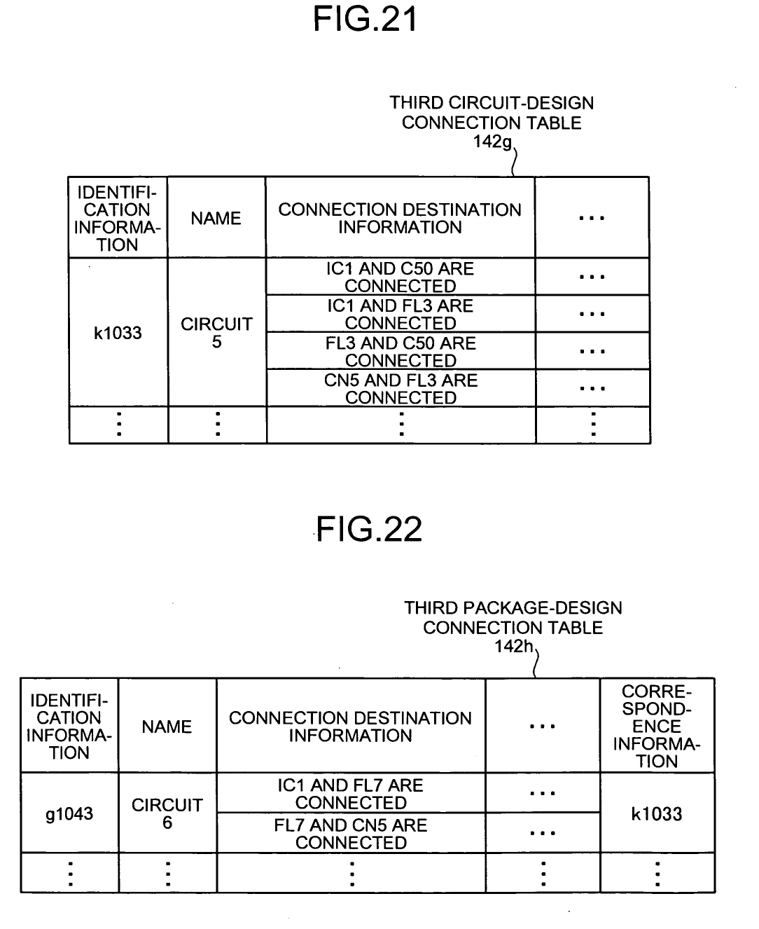

Specifically, the fifth correlation processor 155 creates the third circuit-design connection table 142g based on the first net information 140a. FIG. 21 is one example of a data structure of the third circuit-design connection table 142g. The third circuit-design connection table 142g contains items including identification information that identifies the circuit, its name, and connection destination information. The first line of FIG. 21 indicates that IC1 and FL7 are connected.

The fifth correlation processor 155 also creates the third package-design connection table 142h based on the second net information 140b. FIG. 22 is one example of a data structure of the third package-design connection table 142h. The third package-design connection table 142h contains items including identification information that identifies the circuit, its name, connection destination information, and correspondence information. The first line of FIG. 22 indicates that IC1 and FL7 are connected.

The fifth correlation processor 155 determines the functions of components contained in each circuit, and correlates the circuits even if their structures differ, by referring to the rule information table 140i, the third circuit-design connection table 142g, and the third package-design connection table 142h. The fifth correlation processor 155 registers information on the correlated circuits in the third package-design connection table 142h and the association table 140j.

The correlation processor 150a correlates the first net information 140a and the second net information 140b using all or part of the first correlation processor 151, the second correlation processor 152, the third correlation processor 153, the fourth correlation processor 154, and the fifth correlation processor 155, creates the association table 140j, and outputs the association table 140j to the output unit 120. Processes performed by the first to the fifth correlation processors 151 to 155, followed by a process performed by the entire correlation processor 150a, are explained. A process performed by the first correlation processor 151 is referred to as a method 1, a process performed by the second correlation processor 152 is referred to as a method 2, a process performed by the third correlation processor 153 is referred to as a method 3, a process performed by the fourth correlation processor 154 is referred to as a method 4, and a process performed by the fifth correlation processor 155 is referred to as a method 5.

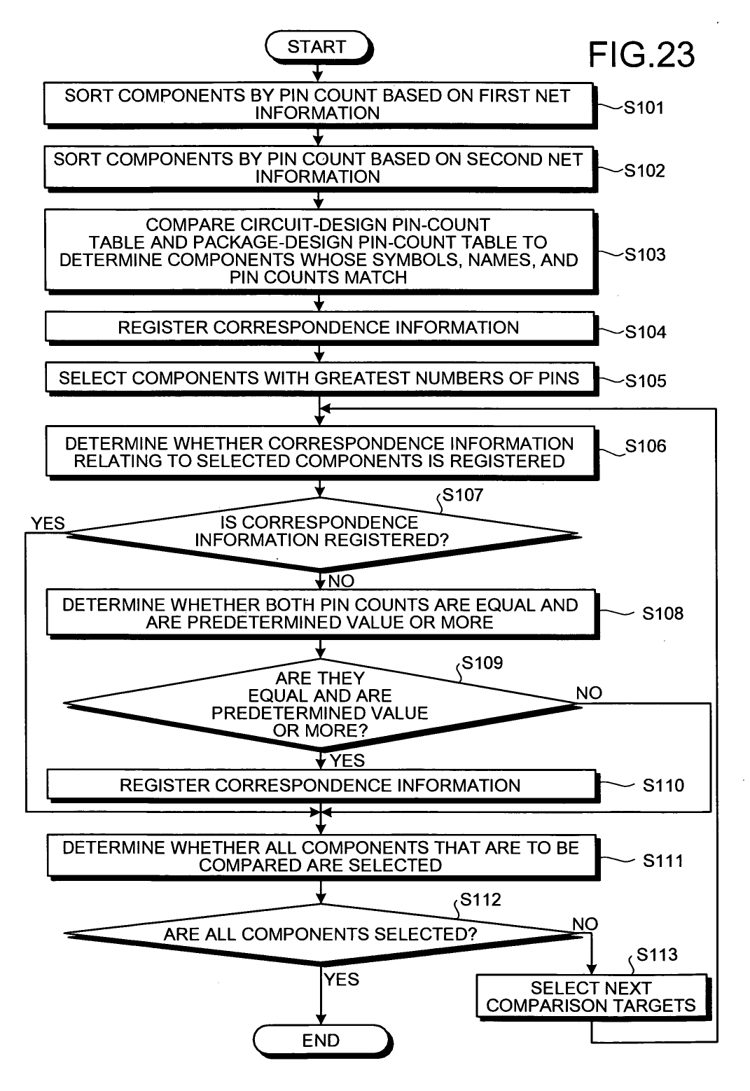

FIG. 23 is a flowchart of the operation of the first correlation processor 151. The first correlation processor 151 sorts the components according to their pin counts based on the first net information 140a, and creates the circuit-design pin-count table 140c (step S101). The first correlation processor 151 then sorts the components according to their pin counts based on the second net information 140b, and creates the package-design pin-count table 140d (step S102).

The first correlation processor 151 compares the circuit-design pin-count table 140c with the package-design pin-count table 140d, determines components whose symbols, names, and pin counts match (step S103), and registers correspondence information relating to matching components in the package-design pin-count table 140d and the association table 140j (step S104).

The first correlation processor 151 selects components with the greatest number of pins (step S105), and determines whether correspondence information relating to the selected components is registered (step S106). If it is registered (Yes at step S107), the process proceeds to step S111 (explained later).

If correspondence information relating to the selected components is not registered (No at step S107), the first correlation processor 151 determines whether the both have the same number of pins and their pin counts are equal to or greater than a predetermined value (whether the pin counts are ranked within the top three) (step S108). If both pin counts are not the same, or the pin counts are smaller than the predetermined value (No at step S109), the process proceeds to step S111 (explained later).

If both components have the same number of pins, and both pin counts are equal to or greater than the predetermined value (Yes at step S109), the first correlation processor 151 registers correspondence information relating to both components in the package-design pin-count table 140d and the association table 140j (step S110).

The first correlation processor 151 then determines whether all components that are to be compared have been selected (step S111). If all the components have not been selected (No at step S112), the first correlation processor 151 selects the next components to be compared (step S113) and the process proceeds to step S106. If all the components are selected (Yes at step S112), the process ends.

The first correlation processor 151 correlates components of the first net information 140a with components of the second net information 140b based on the number of their terminals (pin count), and therefore, the components can be correlated appropriately even if they do not completely match.

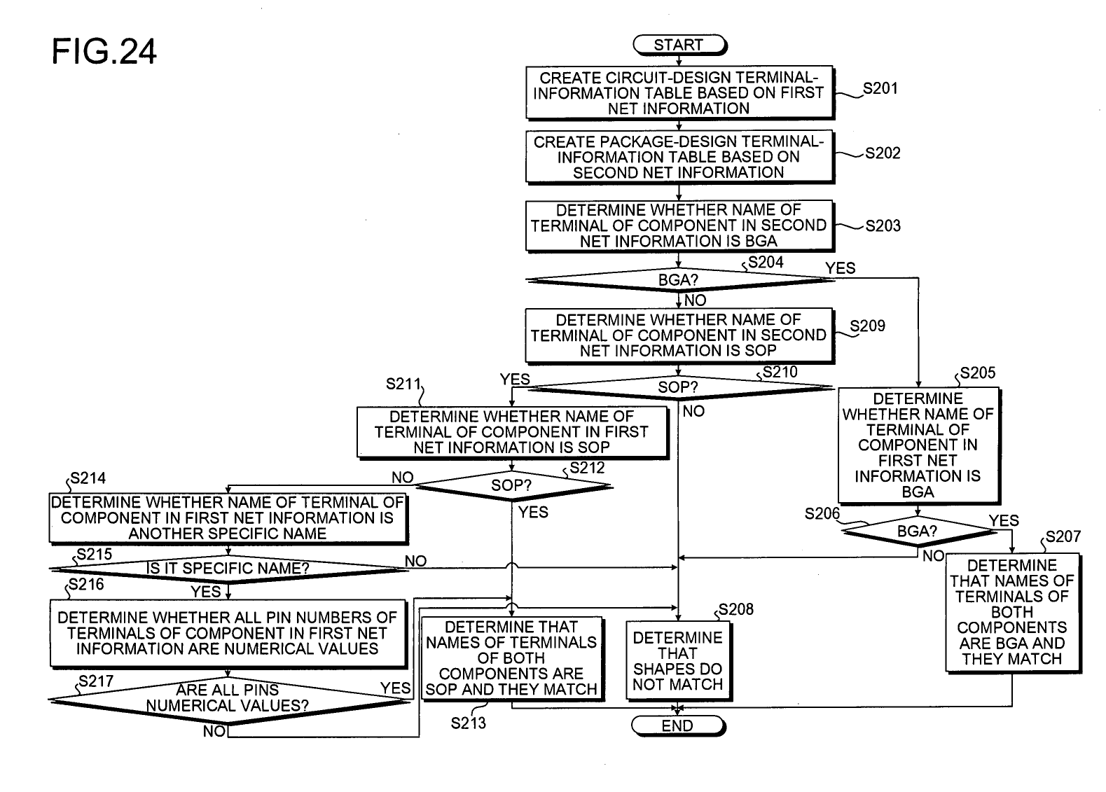

FIG. 24 is a flowchart of the operation of the second correlation processor 152. The second correlation processor 152 creates the circuit-design terminal-information table 140e based on the first net information 140a (step S201), and creates the package-design terminal-information table 140f based on the second net information 140b (step S202).

The second correlation processor 152 then determines whether the name of a terminal of a component in the second net information 140b is BGA (step S203). If the name of the terminal of the component in the second net information 140b is BGA (Yes at step S204), the second correlation processor 152 determines whether the name of a terminal of a component in the first net information 140a is BGA (step S205). If the name of the terminal of a component in the first net information 140a is BGA (Yes at step S206), the second correlation processor 152 determines that the names of terminals of both components are BGA, and that they therefore match (step S207).

Upon determining at step S207 that the names of terminals of both components are BGA and therefore match, the second correlation processor 152 creates a pin arrangement image of each component, searches the component direction in which the pin arrangements match, and, if they match, correlates the components, their terminals, and their nets (see FIG. 13).

When the name of the terminal of the component in the first net information 140a is not BGA (No at step S206), the second correlation processor 152 determines that their shapes do not match (step S208).

Upon determining that the name of the terminal of the component in the second net information 140b is not BGA (No at step S204), the second correlation processor 152 determines whether the name of the terminal of the component in the second net information 140b is SOP (step S209). If it is not SOP (No at step S210), the process proceeds to step S208.

If the name of the terminal of the component in the second net information 140b is SOP (Yes at step S210), the second correlation processor 152 determines whether the name of the terminal of the component in the first net information 140a is SOP (step S211). If the name of the terminal of the component in the first net information 140a is SOP (Yes at step S212), the second correlation processor 152 determines that the names of the terminals of both components are SOP and that they therefore match (step S213).

Upon determining at step S213 that the names of the terminals of both components are SOP and that they match, the second correlation processor 152 creates a pin arrangement image of each component, searches the component direction with which the pin arrangements match, and, if they match, correlates the components, their terminals, and their nets (see FIG. 13).

Upon determining that the name of the terminal of the component in the second net information 140b is not SOP (No at step S212), the second correlation processor 152 determines whether the name of the terminal of the component in the first net information 140a is another specific name (step S214). If it is not a specific name (No at step S215), the process proceeds to step S208.

When the name of the terminal of the component in the first net information 140a is another specific name (Yes at step S215), the second correlation processor 152 determines whether all pin numbers of the terminals of the component in the first net information 140a are numerical values (step S216). If all the pin numbers are numerical values (Yes at step S217), the process proceeds to step S213, and if they are not (No at step S217), the process proceeds to step S208.

Thus, the second correlation processor 152 focuses on the arrangement of terminals of components in correlating a component of the first net information 140a with that of the second net information 140b. Therefore, both the components can be efficiently correlated even if they do not completely match. The process shown in FIG. 24 is performed for components of the circuit-design terminal-information table 140e and of the package-design terminal-information table 140f.

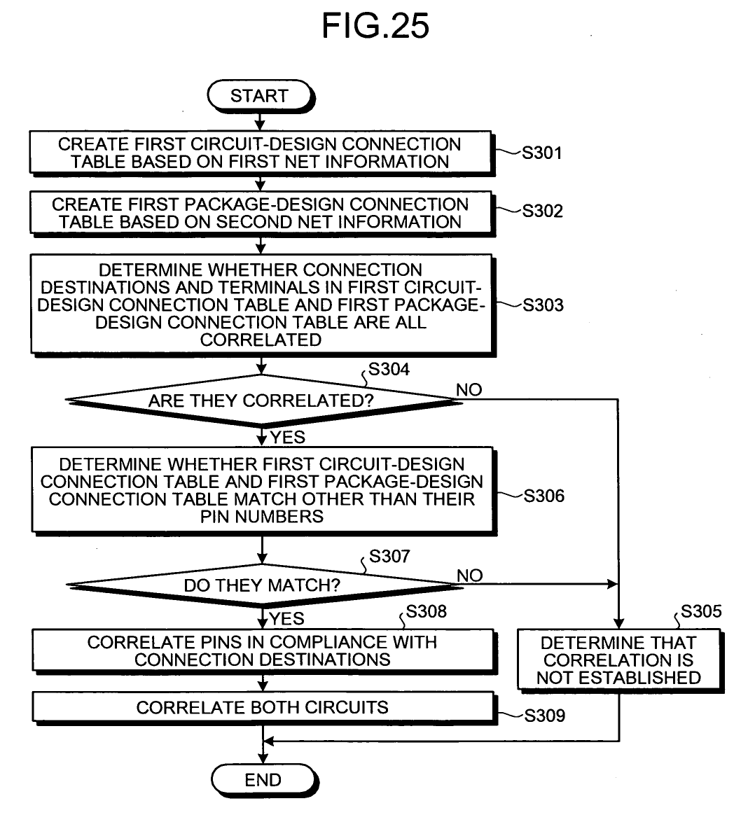

FIG. 25 is a flowchart of the operation of the third correlation processor 153. The third correlation processor 153 creates the first circuit-design connection table 140g based on the first net information 140a (step S301), and creates the first package-design connection table 140h based on the second net information 140b (step S302).

The third correlation processor 153 determines whether the connection destinations and the terminals in the first circuit-design connection table 140g and the first package-design connection table 140h are all correlated (step S303). If they are not all correlated (No at step S304), the third correlation processor 153 determines that correlation is not established (step S305).

When they are correlated (Yes at step S304), the third correlation processor 153 determines whether the first circuit-design connection table 140g and the first package-design connection table 140h match other than their pin numbers (step S306). If they do not match (No at step S307), the process proceeds to step S305.

If they do match (Yes at step S307), the third correlation processor 153 correlates the pins of the connection destinations (step S308), and registers correspondence information correlating both circuits, in the association table 140j (step S309).

The third correlation processor 153 correlates a circuit of the first net information 140a with a circuit of the second net information 140b based on the correspondence relationship between the components of the circuits. Therefore, even if the pin numbers of the components connected to nets contained in the circuits are different, i.e., even if both the circuit do not completely match, the circuit of the first net information 140a and the circuit of the second net information 140b can be correlated efficiently.

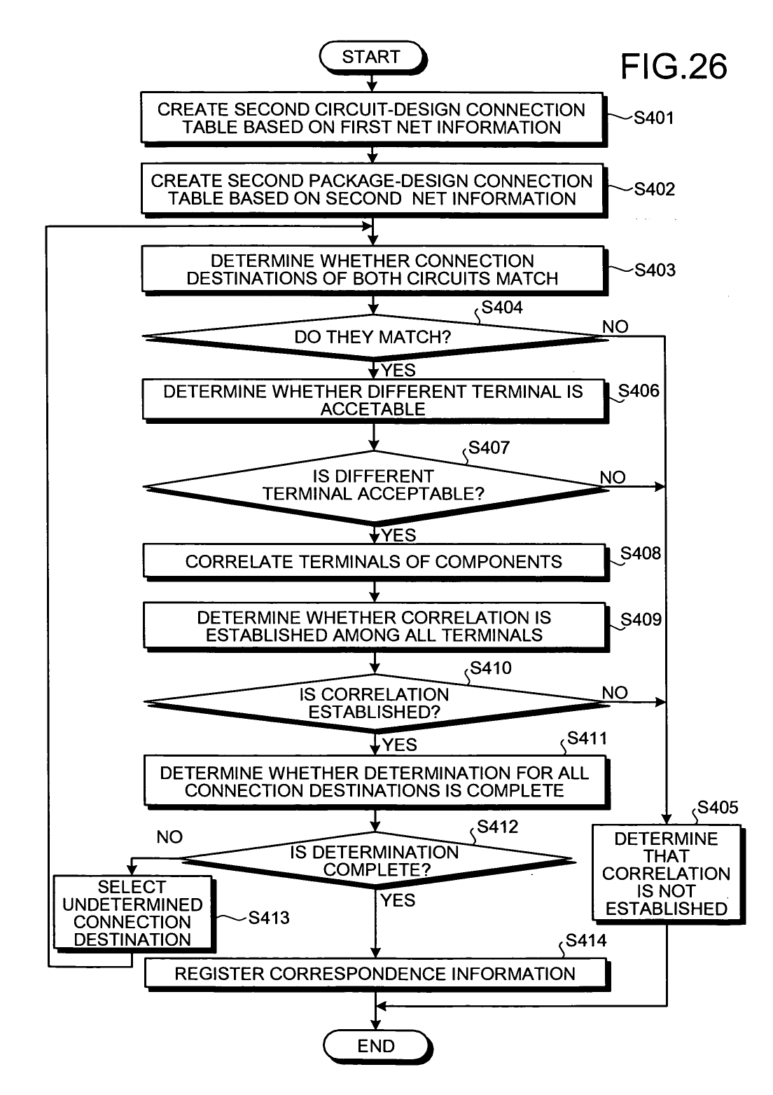

FIG. 26 is a flowchart of the operation of the fourth correlation processor 154. The fourth correlation processor 154 creates the second circuit-design connection table 141g based on the first net information 140a (step S401), and creates the second package-design connection table 141h based on the second net information 140b (step S402).

The fourth correlation processor 154 then determines whether the connection destinations of both circuits match (step S403). If they do not match (No at step S404), the fourth correlation processor 154 determines that correlation is not established (step S405).

When the connection destinations of both the circuits match (Yes at step S404), the fourth correlation processor 154 determines whether a different terminal (or component) is acceptable (i.e., the fourth correlation processor 154 estimates the function of the terminals or the components, refers to the rule information table 140i, and determines whether the functions in the circuits need not match) (step S406). If a different terminal is not acceptable (No at step S407), the process proceeds to step S405.

If a different terminal is acceptable (Yes at step S407), the fourth correlation processor 154 correlates the terminals of the components (step S408), and determines whether correlation is established among all terminals (step S409). If correlation among all terminals is not established (No at step S410), the process proceeds to step S405.

When correlation among all terminals is established (Yes at step S410), the fourth correlation processor 154 determines whether determination is complete for all connection destinations (step S411). If it is not complete (No at step S412), the fourth correlation processor 154 selects an undetermined connection destination (step S413), and the process proceeds to step S403. If determination of all connection destinations is complete (Yes at step S412), the fourth correlation processor 154 registers correspondence information in the second package-design connection table 141h and the association table 140j (step S414).

The fourth correlation processor 154 correlates the circuits based on the rule information table 140i even if the components or the terminals of the circuits do not match. Thus, a circuit of the first net information 140a can be efficiently correlated with a circuit of the second net information 140b.

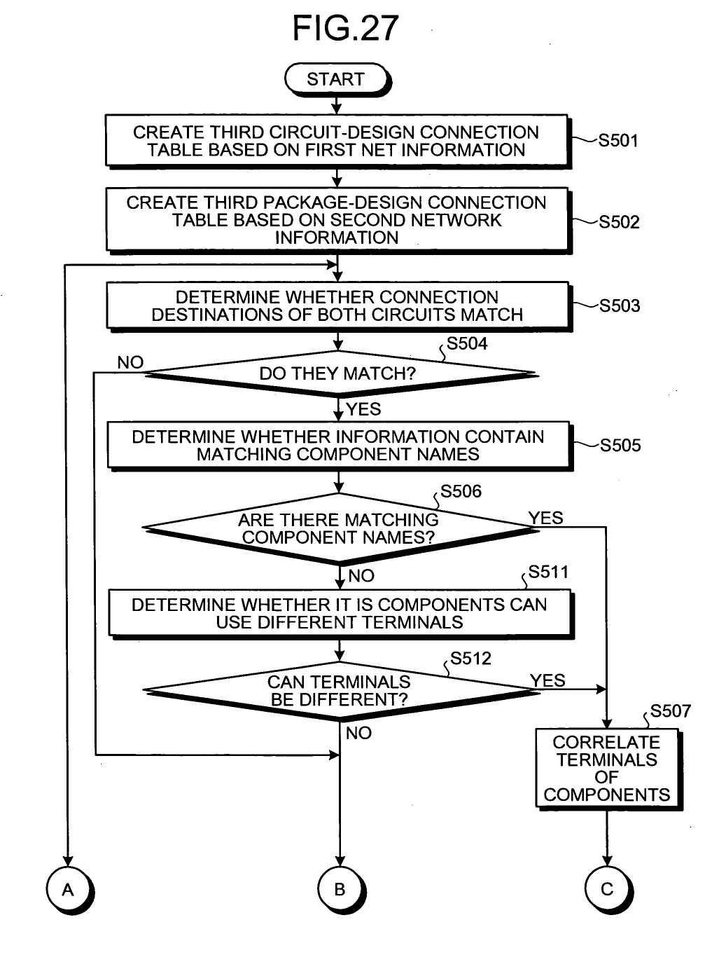

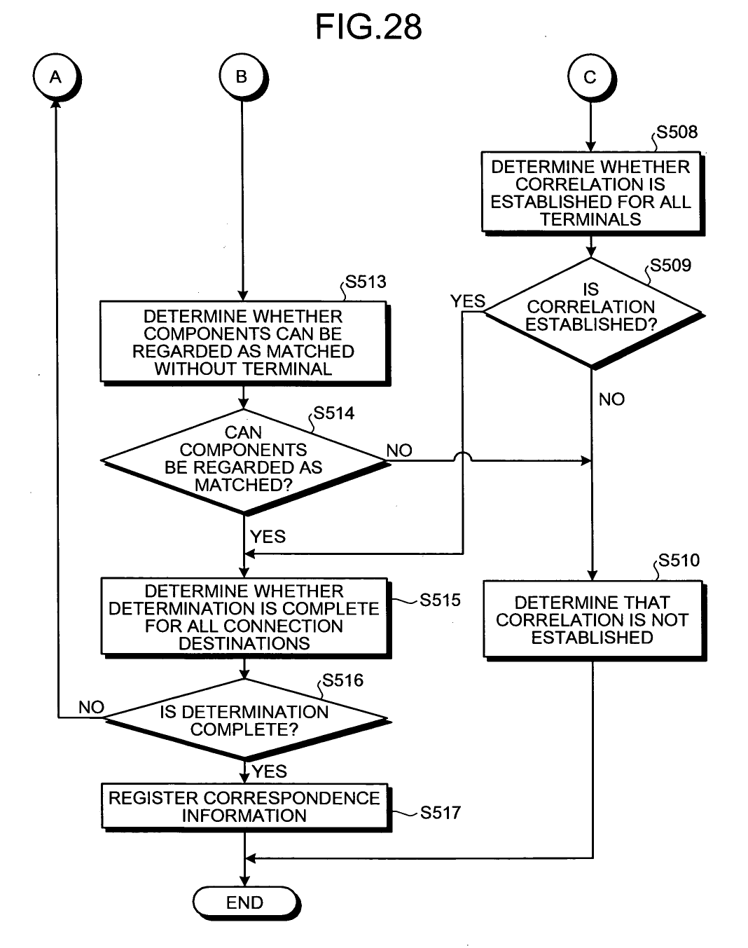

A process performed by the fifth correlation processor 155 is explained referring to FIGS. 27 and 28. Where necessary, this process is performed in combination with the method 3 and the method 4. The fifth correlation processor 155 creates the third circuit-design connection table 142g based on the first net information 140a (step S501), and creates the third package-design connection table 142h based on the second net information 140b (step S502).

The fifth correlation processor 155 then determines whether the connection destinations of both circuits match (step S503). If they do not match (No at step S504), the process proceeds to step S513 (described later).

If the connection destinations of both circuits match (Yes at step S504), the fifth correlation processor 155 determines whether the third circuit-design connection table 142g and the third package-design connection table 142h contain matching component names (step S505). If matching component names exist (Yes at step S506), the fifth correlation processor 155 correlates the terminals of the components (step S507), and determines whether correlation is established for all terminals (step S508).

When correlation is not established for all terminals (No at step S509), the fifth correlation processor 155 determines that correlation is not established (step S510). When correlation is established (Yes at step S509), the process proceeds to step S515 (described later).

When matching component names do not exist in the third circuit-design connection table 142g and the third package-design connection table 142h (No at step S506), the fifth correlation processor 155 determines whether the components can use different terminals (step S511). If the terminals can be different (Yes at step S512), the process proceeds to step S507.

If the terminals cannot be different (No at step S512), the fifth correlation processor 155 determines whether the components can be regarded as matched without the terminal (step S513). If it cannot be regarded as matched without the component (No at step S514), the process proceeds to step S510.

If the circuit can be regarded as matched without the component (Yes at step S514), the fifth correlation processor 155 determines whether determination is complete for all connection destinations (step S515). When it is not complete (No at step S516), the process proceeds to step. S503. When determination is complete for all connection destinations (Yes at step S516), the fifth correlation processor 155 registers correspondence information in the third package-design connection table 142h and the association table 140j (step S517).

In this way, the fifth correlation processor 155 can correlate a circuit of the first net information 140a with a circuit of the second net information 140b based on predetermined rules even if the structures of the circuits differ.

A process performed by the correlation processor 150a is explained. The correlation processor 150a sequentially performs the methods 1 to 5 for each localized portion of the circuit until it eventually covers the entire circuit, thereby correlating the first net information 140a and the second net information 140b. As an example, two types of processes (basic method 1 and basic method 2) are explained. The basic method 1 is performed by sequentially applying the methods 1 to 5 to each component, while the basic method 2 is performed by sequentially applying the methods 1 to 5 to all the components.

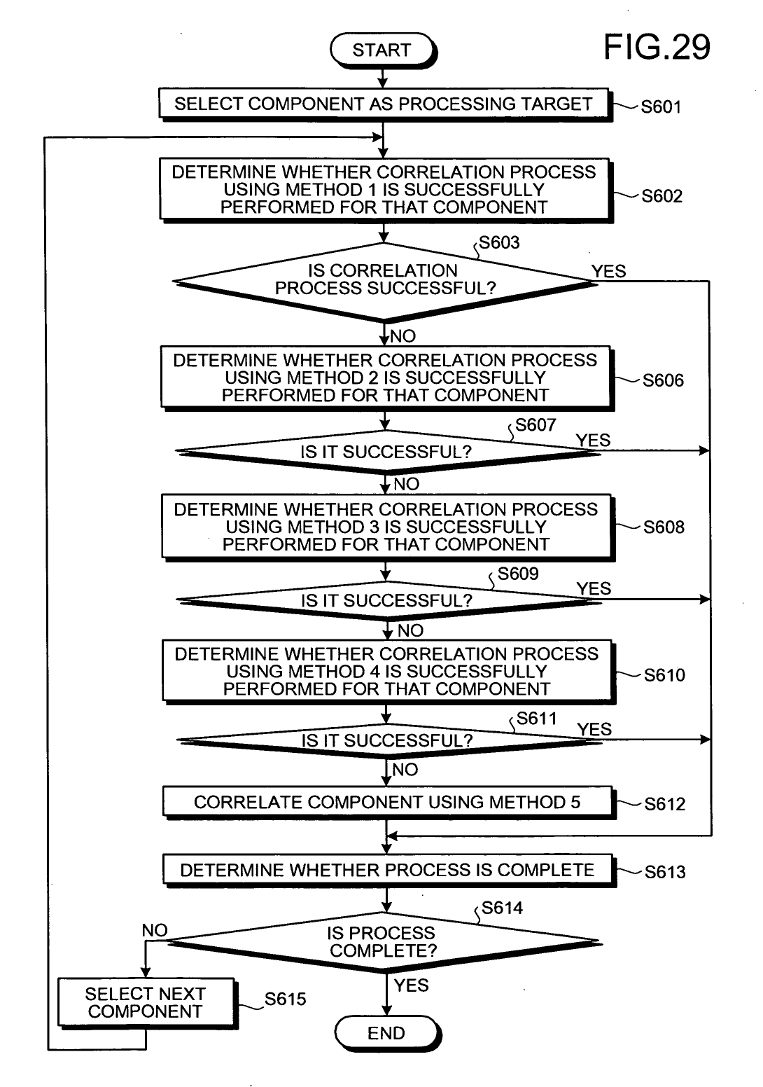

FIG. 29 is a flowchart of a process according to the basic method 1. The correlation processor 150a selects a component as a processing target (step S601), and determines whether a correlation process using the method 1 is successfully performed for that component (step S602).

When the correlation process using the method 1 is successfully performed for the component (Yes at step S603), the correlation processor 150a determines whether the process is complete (step S613). If the process is complete (Yes at step S614), the process ends. If the process is not complete (No at step S614), the correlation processor 150a selects the next component (step S615) and the process proceeds to step S602.

When the correlation process using the method 1 is unsuccessful for the component (No at step S603), the correlation processor 150a determines whether a correlation process using the method 2 is successfully performed for that component (step S606).

When the correlation process using the method 2 is successfully performed for the component (Yes at step S607), the process proceeds to step S613. On the other hand, when the correlation process using the method 2 is unsuccessful for that component (No at step S607), the correlation processor 150a determines whether a correlation process using the method 3 is successfully performed for that component (step S608).

When the correlation process using the method 3 is successfully performed for the component (Yes at step S609), the process proceeds to step S613. On the other hand, when the correlation process using the method 3 is unsuccessful for that component (No at step S609), the correlation processor 150a determines whether a correlation process using the method 4 is successfully performed for that component (step S610).

When the correlation process using the method 4 is successfully performed for the component (Yes at step S611), the process proceeds to step S613. On the other hand, when the correlation process using the method 4 is unsuccessful for that component (No at step S611), the correlation processor 150a correlates the component using the method 5 (step S612) and the process proceeds to step S613.

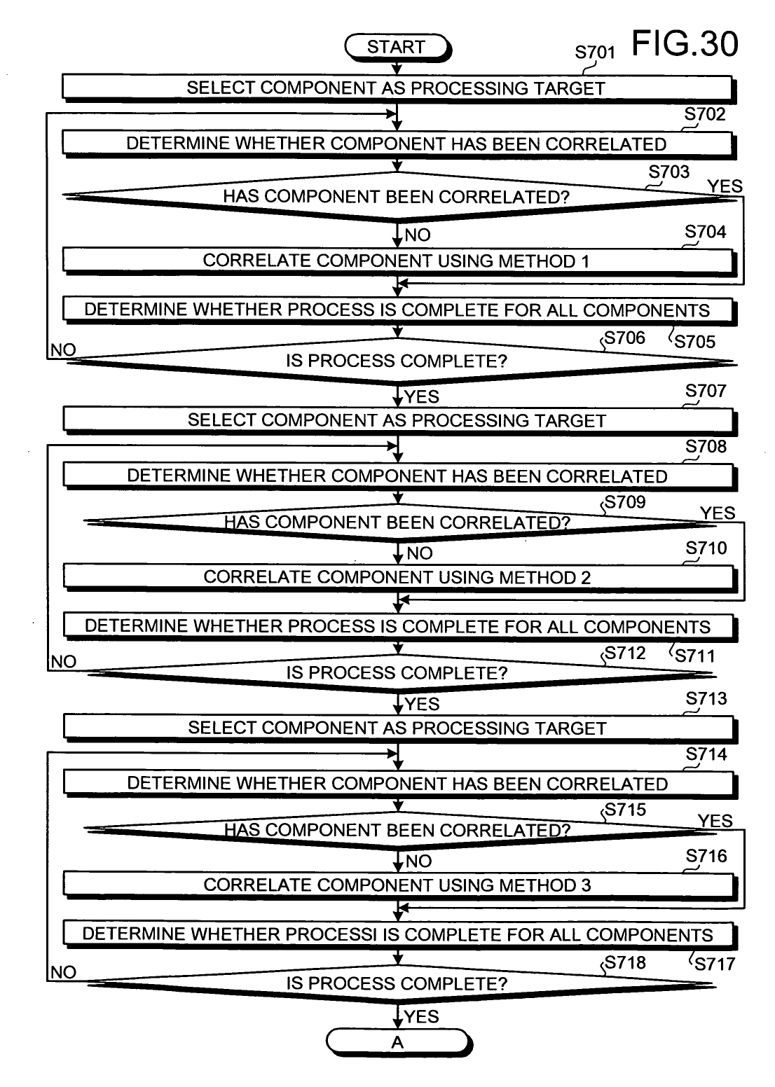

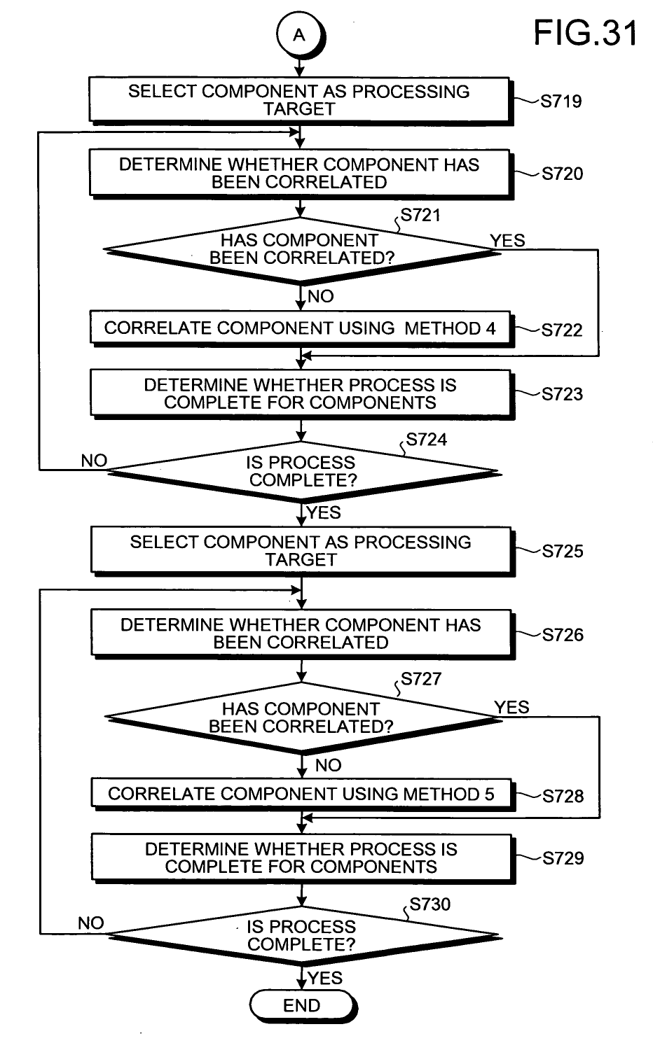

FIGS. 30 and 31 are flowcharts of a process performed by using the basic method 2. As shown in FIG. 30, the correlation processor 150a selects a component as a processing target (step S701), and determines whether the correlation process has been performed for the component (step S702). If the correlation process has been performed (Yes at step S703), the process proceeds to step S705 (described later).

If the correlation process has not been performed (No at step S703), the correlation processor 150a performs the correlation process using the method 1 (step S704), and determines whether the process is complete for all components (step S705). If the process is not complete (No at step S706), the process proceeds to step S702.

If the process is complete (Yes at step S706), the process proceeds to the correlation process performed by using the method 2, the correlation processor 150a selects a component as a processing target (step S707), and determines whether the correlation process has been performed for that component (step S708). If the correlation process has been performed (Yes at step S709), the process proceeds to step S711 (described later).

If the correlation process has not been performed (No at step S709), the correlation processor 150a performs the correlation process for the component using the method 2 (step S710), and determines whether the process is complete for all components (step S711). If the process is not complete (No at step S712), the process proceeds to step S708.

If the process is complete for all components (Yes at step S712), the process proceeds to the method 3, wherein the correlation processor 150a selects a component as a processing target (step S713), and determines whether the correlation process has been performed for that component (step S714). If the correlation process has been performed (Yes at step S715), the process proceeds to step S717 (described later).

If the correlation process has not been performed (No at step S715), the correlation processor 150a performs the correlation process for the component using the method 3 (step S716), and determines whether the process is complete for all components (step S717). If the process is not complete (No at step S718), the process proceeds to step S714.

If the process is complete for all components (Yes at step S718), the process proceeds to the method 4, wherein the correlation processor 150a selects a component as a processing target (step S719), and determines whether the correlation process has been performed for that component (step S720). If the correlation process has been performed (Yes at step S721), the process proceeds to step S723 (described later).

If the correlation process has not been performed (No at step S721), the correlation processor 150a performs the correlation process for the component using the method 4 (step S722), and determines whether the processing is complete for all components (step S723). If the process is not complete (No at step S724), the process proceeds to step S720.

If the process is complete for all components (Yes at step S724), the process proceeds to the method 5, wherein the correlation processor 150a selects a component as a processing target (step S725), and determines whether the correlation process has been performed for that component (step S726). If the correlation process has been performed (Yes at step S727), the process proceeds to step S729 (described later).

If the correlation process has not been performed (No at step S727), the correlation processor 150a performs the correlation process for the component using the method 5 (step S728), and determines whether the process is complete for all components (step S729). If the process is not complete (No at step S730), the process proceeds to step S726. If the process is complete (Yes at step S730), the process ends.

In the basic methods 1 and 2, the correlation processor 150a performs the methods 1 to 5 only once to all the components (including terminals and nets). Components whose correlation process fails due to insufficient information caused by noncompliant surrounding circuits at the time of that one processing are sometimes successfully correlated in subsequent processing after their surrounding components are correlated. Therefore, the compliant portion of the circuit (including components, terminals, and nets) can be increased by repeatedly performing the correlation process for the entire circuit (repeatedly executing the basic method 1 or the basic method 2).

Before the correlation processor 150a performs the correlation process, or during execution of the correlation process, the user can create data on the correspondence relationship of the components, terminals, and nets, and input the created data to the CAD data processing apparatus 100, thereby increasing the compliant locations and enhancing correspondence precision. For example, the user can create data on primary components (including primary terminals and nets) among components, terminals, and nets contained in the first net information 140a and the second net information 140b, and input it beforehand to the CAD data processing apparatus 100. This confirms the correspondence relationship between the primary components, and therefore, surrounding circuits can be easily and reliably correlated using these primary components as a starting point.

Alternatively, the user can create data on the correspondence relationship of components, terminals, and nets that are keys for the correlation process (locations where the correlation process is difficult or impossible to determine) and input this data to the CAD data processing apparatus 100 (i.e., by allowing the user to input the minimum data required). This reduces the load on the user, and enables required locations to be efficiently correlated.

A process performed by the correlation processor 150a for selecting a component as a correlation target is explained. The correlation process starts with central components of the circuit, more complex components being correlated later, thereby increasing the efficiency of the correlation process. A method used by the correlation processor 150a in selecting a component as a target for the correlation process is explained. In the example of the embodiment, selection methods 1 to 5 are explained in this order. The correlation processor 150a uses any of the selection methods 1 to 5 in selecting a component (including terminals and nets) as a target for the correlation process.

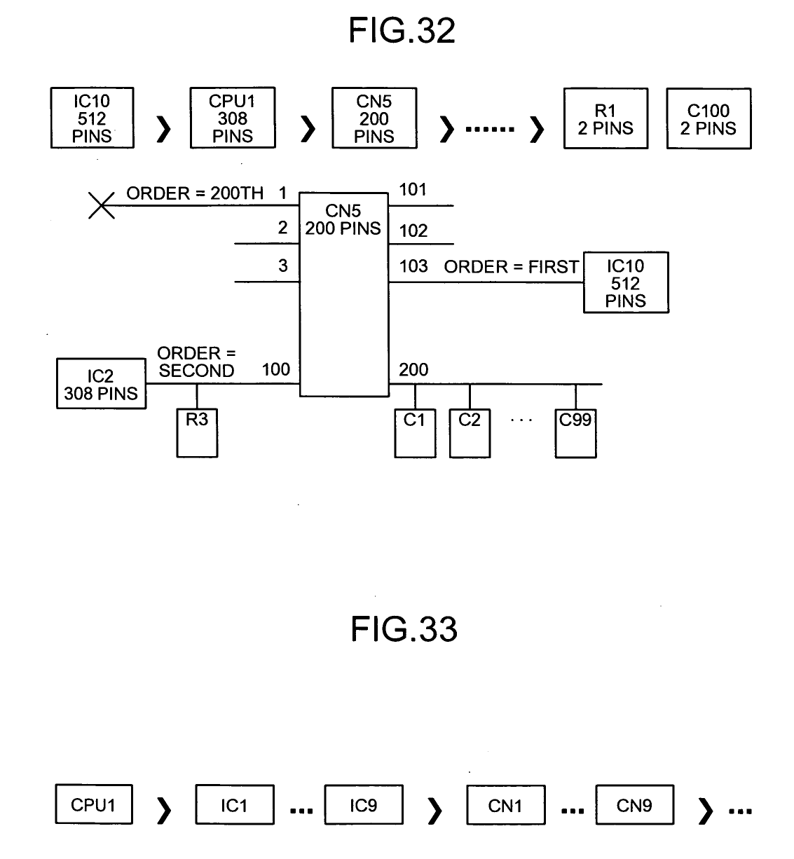

The selection method 1 is explained first. FIG. 32 is a schematic for explaining the selection method 1. The selection method 1 processes components in descending order of their terminal numbers. Similarly, the sequence for processing terminal in the target component is in descending order of their terminal numbers of their components. In the example shown in FIG. 32, components are selected in the order IC10 (512 pins), CPU1 (308 pins), CN5 (200 pins), . . . , R1 (two pins), and C100 (two pins), and the first net information 140a is correlated with the second net information 140b. Components with the large number of terminals (large pin counts) are usually important, and therefore, the components, the terminals, and the nets can be efficiently correlated.

FIG. 33 is a schematic for explaining the selection method 2. The selection method 2 processes symbols (names) of components and terminals according to a sequence in which they can be estimated as more important. Symbols of the components and the terminals are estimated from their arrangement and the like. Prioritized symbols and their degrees of priority are determined using conventional rules as well as characteristics of the circuit data. In the example shown in FIG. 33, the correlation process is performed in the order of CPU1, IC1, . . . , IC9, CN1, . . . . Data on prioritized symbols and their degrees of priority (not shown in FIG. 1) is stored in the storage unit 140.

The selection method 3 is explained. The selection method 3 uses the selection method 1, the selection method, and another method. The selection method 3 uses the method 2 to sort the components in descending order of their degrees of priority, and, when components of equal order exist, additionally uses the method 1 to determine their order of priority. The selection method 3 is explained in detail with reference to FIG. 33. When the order of priority is determined using the method 2, IC1 to IC9 have the same order. By applying the method 1 to IC1 to IC9, their order of priority can be determined efficiently (the same applies to CN1 to CN9).

The selection method 4 is explained. The selection method 4 uses the selection method 1, the selection method 2, and another method. The selection method 4 uses the method 1 for components whose pin counts exceed a predetermined value (e.g., equal to or more than 100 pins), and uses the method 2 for all other components. In the selection method 4, determination is controlled according to the component that is the target of the correlation process. For example, “determination according to pin arrangement” is meaningless for a component having only two pins, and need not be applied. Also, it is better not to apply a determination of “net connection based on connection destination component” to a component that is estimated to be a primary functional unit having many pins because a circuit connection that has an actual difference, such as a parallel bus, will be mistakenly identified as a pin swap and mistakenly correlated.

The selection method 5 is explained. The selection method 5 appends four parts weight to the pin count of a component, and six parts weight to its symbol, calculates an evaluation score, and correlates components, terminals, and nets in the descending order of their calculated evaluation scores. The method of calculating the evaluation score can be expressed as:

Evaluation score=Descending order ranking of pin count/total number of components×4+symbol score. One example of a symbol score is CPU: 6 points, IC: 4 points, CN: 3 points, TR: 2 points. Data on symbol scores (not shown) is stored in the storage unit 140.

As described above, according to the CAD data processing apparatus 100 of the embodiment, the first net information 140a and the second net information 140b are acquired from the input unit 110 and stored in the storage unit 140, and the correlation processor 150a creates the association table 140j that correlates components, terminals, and nets contained in the first net information 140a with components, terminals, and nets contained in the second net information 140b, based on characteristics of terminals included in components contained in the first net information 140a and the second net information 140b. Therefore, the first CAD data and the second CAD data (the first net information 140a and the second net information 140b) can be correlated appropriately even when symbol names and nets they contain do not completely match.

According to the embodiment, similar locations (locations of matching characteristics) in a circuit (components, terminals, and nets) of the first net information 140a and a circuit of the second net information 140b can be determined by comparing them. Therefore, data can be diverted between the circuits even if they do not completely match.

Reliability of the correlation process can be increased by using a plurality of methods (the methods 1 to 5) to determine identical circuit portions, and then correlating components, terminals, and nets of the first net information 140a with those of the second net information 140b based on a comprehensive determination of the results.

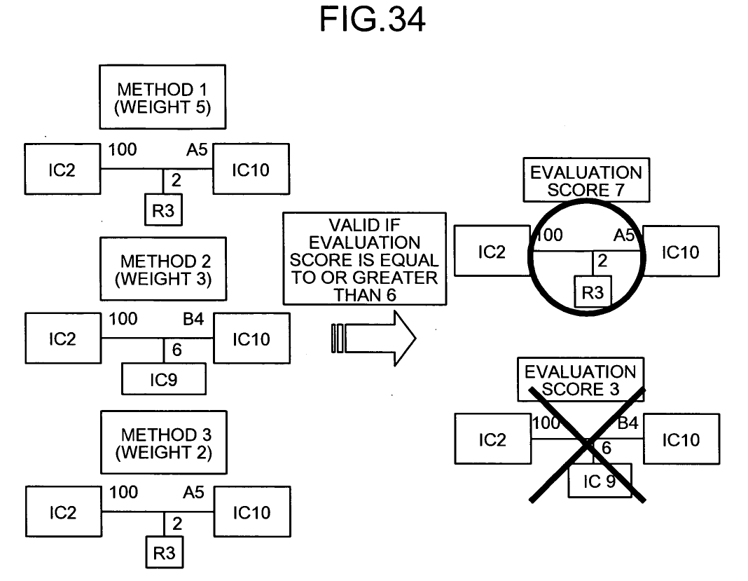

FIG. 34 is a schematic for explaining a comprehensive determination method used by the correlation processor 150a. When the correlation process using the method 1 (weight 5) is successful, 5 is added to the evaluation score (initial value of the evaluation score being zero). When the correlation process using the method 2 (weight 3) is successful, 3 is added to the evaluation score. When the correlation process using the method 3 (weight 2) is successful, 2 is added to the evaluation score (the methods 4 and 5 are omitted). For example, when the correlation process using the methods 1 and 3 is successful, the evaluation score is 7, whereas when the correlation process using the method 2 alone is the only successful one, the evaluation score is 3. When the final score exceeds a threshold (e.g., a score of 6), correlation is finally confirmed for the final components, terminals, and nets. If the final score is below the threshold, correlation of these components, terminals, and nets is unconfirmed.

The CAD data processing apparatus 100 is explained above as hardware; however, it can be implemented as software. In other words, a computer program can be executed on a computer to realize the same function as the CAD data processing apparatus 100.

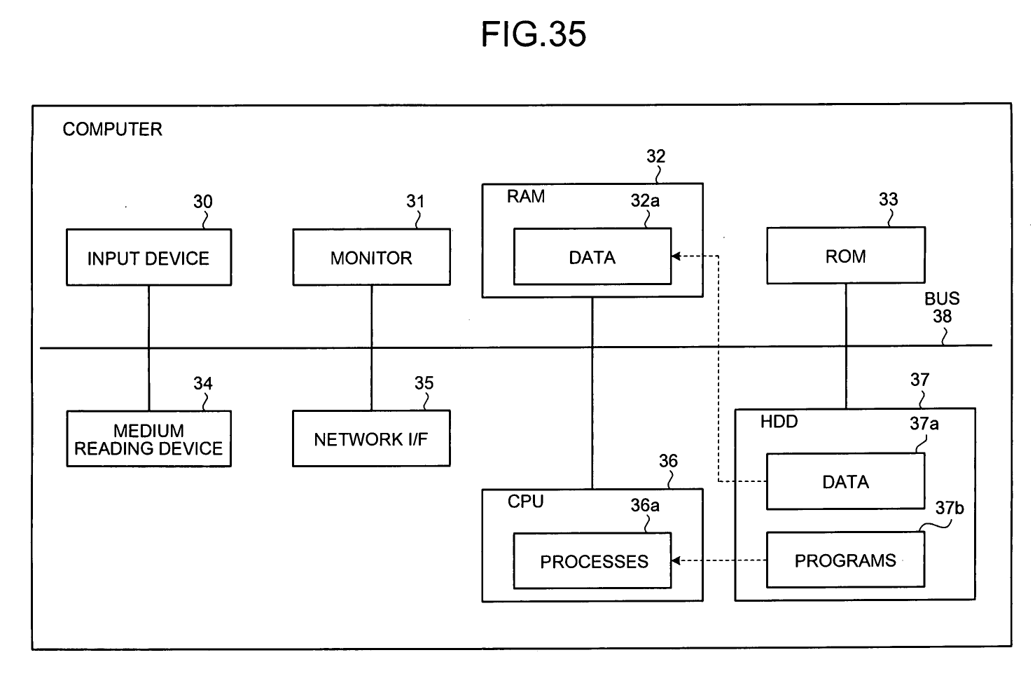

FIG. 35 is a block diagram of a hardware configuration of such a computer. The computer includes an input device 30 that receives data input by a user, a monitor 31, a random access memory (RAM) 32, a read only memory (ROM) 33, a medium reading device 34 that reads various programs recorded in a recording medium, a network interface (I/F) 35 that exchanges data with other computers via a network, a central processing unit (CPU) 36, and a hard disk drive (HDD) 37, these being connected by a bus 38.

Various programs 37b that realize the same function as the CAD data processing apparatus 100 described above are stored in the HDD 37. The CPU 36 reads the programs 37b from the HDD 37 and executes them, whereby various processes 36a corresponding to the functions of the functional units of the CAD data processing apparatus 100 are activated.

The processes 36a corresponding to data stored in the storage unit 140 of the CAD data processing apparatus 100 (the first net information 140a, the second net information 140b, the circuit-design pin-count table 140c, the package-design pin-count table 140d, the circuit-design terminal-information table 140e, the package-design terminal-information table 140f, the first circuit-design connection table 140g, the second circuit-design connection table 141g, the third circuit-design connection table 142g, the first package-design connection table 140h, the second package-design connection table 141h, the third package-design connection table 142h, the rule information table 140i, and the association table 140j) are stored in the HDD 37. The CPU 36 stores various data 37a in the HDD 37, reads the data 37a from the HDD 37 and stores it in the RAM 32, and performs data processing based on various data 32a stored in the RAM 32.

The programs 37b are not necessarily stored in the HDD 37 from beginning. For example, the programs 37b can be stored in a portable physical medium inserted into the computer, such as a flexible disk (FD), a compact disc-read only memory (CD-ROM), a digital versatile disk (DVD), a magneto-optical disk, an integrated circuit (IC) card, or in a fixed physical medium such as an HDD inside the computer or outside it. The computer can execute the programs 37b by reading them from the medium. The programs 37b can also be downloaded from another computer (or server) connected to the computer via a public line, the Internet, a local area network (LAN), a wide area network (WAN), or the like.

Of the respective processes explained in the embodiment, all or a part of the processes explained as being performed automatically can be performed manually, or all or a part of the processes explained as being performed manually can be performed automatically in a known method.

The process procedures, control procedures, specific names, and information including various types of data and parameters mentioned in the above description and the drawings can be arbitrarily changed unless otherwise specified.

The respective constituents of the illustrated apparatus are functionally conceptual, and need not necessarily be physically configured as illustrated. In other words, the specific mode of arrangement of the apparatus is not limited to that shown in the drawings, and can be functionally or physically separated or integrated, partly or wholly, according to the load or usage.

The same function of the apparatus can be entirely or partially realized by CPU or a computer program executed by CPU. The apparatus can also be implemented in wired-logic hardware.

According to an embodiment of the present invention, data indicating a component that is not used in correlating the first CAD data and the second CAD data is stored in a recording device. The first CAD data and the second CAD data are correlated based on characteristics of terminals of components from which the unused component has been removed. Therefore, the first CAD data and the second CAD data can be correlated more reliably.

Moreover, correlation process includes first correlating that correlates the first CAD data with the second CAD data based on the number of the terminals, second correlating that correlates the first CAD data with the second CAD data based on an arrangement of the terminals, third correlating that correlates the first CAD data with the second CAD data based on a characteristic of a component connected to a net in a circuit defined by the first CAD data and a characteristic of a component connected to a net in a circuit defined by the second CAD data, and fourth correlating that correlates the first CAD data with the second CAD data based on the characteristics of the terminals of the components from which the unused component has been removed. The first to fourth correlating, the second correlating, the third correlating and the correlating are performed in combination repeatedly. Therefore, it is possible to improve accuracy in locating and determining a point where correlation is established between the first CAD data and the second CAD data.

Although the invention has been described with respect to a specific embodiment for a complete and clear disclosure, the appended claims are not to be thus limited but are to be construed as embodying all modifications and alternative constructions that may occur to one skilled in the art that fairly fall within the basic teaching herein set forth.

What is claimed is:

1. A computer-readable recording medium that stores therein a computer program for correlating computer aided design (CAD) data created by different CADs, the CAD data including data on components having a terminal that constitute a circuit and a net that connects the components, the computer program causing the computer to execute:
storing first CAD data created by a first CAD and second CAD data created by a second CAD; and
correlating the first CAD data with the second CAD data based on characteristics of terminals of components indicated by the first CAD data and the second CAD data.

2. The computer-readable recording medium according to claim 1, wherein the correlating includes correlating the first CAD data with the second CAD data based on number of the terminals.

3. The computer-readable recording medium according to claim 1, wherein the correlating includes correlating the first CAD data with the second CAD data based on an arrangement of the terminals.

4. The computer-readable recording medium according to claim 1, wherein the correlating includes correlating the first CAD data with the second CAD data based on a first characteristic of a component connected to a first net in a circuit defined by the first CAD data and a second characteristic of a component connected to a second net in a circuit defined by the second CAD data.

5. The computer-readable recording medium according to claim 4, wherein the correlating includes
comparing the first characteristic with the second characteristic; and
correlating the first CAD data with the second CAD data when the first characteristic and the second characteristic match even if each of the first net and the second net is connected to the component via a terminal with a different terminal number.

6. The computer-readable recording medium according to claim 1, the computer program further causing the computer to execute storing unused component data that indicates at least one unused component not used in correlating the first CAD data with the second CAD data, wherein
the correlating includes correlating the first CAD data with the second CAD data based on the characteristics of the terminals of the components from which the unused component has been removed.

7. The computer-readable recording medium according to claim 6, wherein the correlating includes
first correlating that correlates the first CAD data with the second CAD data based on number of the terminals;
second correlating that correlates the first CAD data with the second CAD data based on an arrangement of the terminals;
third correlating that correlates the first CAD data with the second CAD data based on a characteristic of a component connected to a net in a circuit defined by the first CAD data and a characteristic of a component connected to a net in a circuit defined by the second CAD data;
fourth correlating that correlates the first CAD data with the second CAD data based on the characteristics of the terminals of the components from which the unused component has been removed; and
repeating the first correlating, the second correlating, the third correlating and the fourth correlating in combination.

8. A CAD data processing apparatus that correlates CAD data created by different CADs, the CAD data including data on components having a terminal that constitute a circuit and a net that connects the components, the CAD data processing apparatus comprising:
a storage unit that stores therein first CAD data created by a first CAD and second CAD data created by a second CAD; and
a correlating unit that correlates the first CAD data with the second CAD data based on characteristics of terminals of components indicated by the first CAD data and the second CAD data.

9. The CAD data processing apparatus according to claim 8, wherein the correlating unit correlates the first CAD data with the second CAD data based on number of the terminals.

10. The CAD data processing apparatus according to claim 8, wherein the correlating unit correlates the first CAD data with the second CAD data based on an arrangement of the terminals.

11. The CAD data processing apparatus according to claim 8, wherein the correlating unit correlates the first CAD data with the second CAD data based on a characteristic of a component connected to a net in a circuit defined by the first CAD data and a characteristic of a component connected to a net in a circuit defined by the second CAD data.

12. The CAD data processing apparatus according to claim 8, further comprising an unused-component-data storing unit that stores data indicating at least one unused component not used in correlating the first CAD data with the second CAD data, wherein
the correlating unit correlates the first CAD data with the second CAD data based on the characteristics of the terminals of the components from which the unused component has been removed.

13. The CAD data processing apparatus according to claim 12, wherein the correlating unit performs
first correlating that correlates the first CAD data with the second CAD data based on number of the terminals;
second correlating that correlates the first CAD data with the second CAD data based on an arrangement of the terminals;
third correlating that correlates the first CAD data with the second CAD data based on a characteristic of a component connected to a net in a circuit defined by the first CAD data and a characteristic of a component connected to a net in a circuit defined by the second CAD data;
fourth correlating that correlates the first CAD data with the second CAD data based on the characteristics of the terminals of the components from which the unused component has been removed; and
repeating the first correlating, the second correlating, the third correlating and the fourth correlating in combination.

14. A CAD data processing method for correlating CAD data created by different CADs, the CAD data including data on components having a terminal that constitute a circuit and a net that connects the components, the CAD data processing method comprising:
storing first CAD data created by a first CAD and second CAD data created by a second CAD; and
correlating the first CAD data with the second CAD data based on characteristics of terminals of components indicated by the first CAD data and the second CAD data.

15. The CAD data processing method according to claim 14, wherein the correlating includes correlating the first CAD data with the second CAD data based on number of the terminals.

16. The CAD data processing method according to claim 14, wherein the correlating includes correlating the first CAD data with the second CAD data based on an arrangement of the terminals.

17. The CAD data processing method according to claim 14, wherein the correlating includes correlating the first CAD data with the second CAD data based on a characteristic of a component connected to a net in a circuit defined by the first CAD data and a characteristic of a component connected to a net in a circuit defined by the second CAD data.

18. The CAD data processing method according to claim 14, further comprising storing unused component data that indicates at least one unused component not used in correlating the first CAD data with the second CAD data, wherein
the correlating includes correlating the first CAD data with the second CAD data based on the characteristics of the terminals of the components from which the unused component has been removed.

19. The CAD data processing method according to claim 18, wherein the correlating includes
first correlating that correlates the first CAD data with the second CAD data based on number of the terminals;
second correlating that correlates the first CAD data with the second CAD data based on an arrangement of the terminals;
third correlating that correlates the first CAD data with the second CAD data based on a characteristic of a component connected to a net in a circuit defined by the first CAD data and a characteristic of a component connected to a net in a circuit defined by the second CAD data;
fourth correlating that correlates the first CAD data with the second CAD data based on the characteristics of the terminals of the components from which the unused component has been removed; and
repeating the first correlating, the second correlating, the third correlating and the fourth correlating in combination.
